(19) United States
(12) Patent Application Publication
(10) Pub. No.: US 2025/0340396 A1
(43) Pub. Date: Nov. 6, 2025

(54) CARD ATTACHMENT SYSTEM AND METHOD

(71) Applicant: FISERV, INC., Milwaukee, WI (US)

(72) Inventors: Joel Harris, Missouri Valley, IA (US); Ray Stuck, Omaha, NE (US); Jon Gates, Honey Creek, IA (US); Corey Dean Tunink, Blair, NE (US); Jay E. Greene, III, Bellevue, NE (US)

(73) Assignee: FISERV, INC., Milwaukee, WI (US)

(21) Appl. No.: 19/188,642

(22) Filed: Apr. 24, 2025

Related U.S. Application Data
(60) Provisional application No. 63/642,365, filed on May 3, 2024.

(51) Int. Cl. B65H 37/04

(52) U.S. Cl. CPC B65H 37/04; B65H 2301/332; B65H 2404/1441; B65H 2511/10; B65H 2511/416; B65H 2701/1914

(57) ABSTRACT

An apparatus may include a gantry configured to affix a transaction card to a card carrier, a conveyor configured to convey the card carrier to the gantry, a flipper system including a flipper arm configured to engage the card carrier and flip the card carrier onto the conveyor, and a controller. The controller is configured to receive an input including a desired location on the card carrier where the transaction card is to be affixed and a desired orientation of the transaction card on the card carrier, determine that the card carrier has been received by the flipper system, operate the flipper arm to engage the card carrier and flip the card carrier onto the conveyor, move the arm of the gantry based on the one or more inputs, and affix the transaction card to the card carrier by the gantry.

### CROSS-REFERENCE TO RELATED APPLICATIONS

This application claims priority to U.S. Provisional Application No. 63/642,365, filed May 3, 2024, which application is incorporated by reference herein.

### BACKGROUND

Cards such as transaction cards and other objects may be attached to personalized mailings, where the card or other objects are personalized according to the intended recipient. Cards and other objects may be attached to mailings using glue, tape, or other adhesive. This can be a labor-intensive, time-consuming process.

### SUMMARY

Aspects of the present invention are directed to an apparatus. The apparatus includes a gantry including an arm configured to affix a transaction card to a card carrier, a conveyor configured to convey the card carrier to the gantry in a first direction relative to the gantry for affixing the transaction card to the card carrier, a flipper system comprising at least one flipper arm configured to engage the card carrier and flip the card carrier onto the conveyor, and a controller. The at least one flipper arm is configured to flip the card carrier such that a downward facing surface of the card carrier becomes an upward facing surface. The controller is configured to receive one or more inputs comprising at least a desired location on the card carrier where the transaction card is to be affixed and a desired orientation of the transaction card on the card carrier, determine that the card carrier has been received by the flipper system, operate the at least one flipper arm to engage the card carrier and flip the card carrier onto the conveyor, move the arm of the gantry based on the one or more inputs in a second direction perpendicular to the first direction and in a third direction perpendicular to the first direction and the second direction, and affix the transaction card to the card carrier by the arm of the gantry.

In some aspects, prior to operating the at least one flipper arm to engage the card carrier, the controller is also configured to receive, from a sensor system, sensor data associated with the card carrier and determine, based on the sensor data, that the card carrier has been received by the at least one flipper arm.

In some aspects, the controller is also configured to move the arm of the gantry based on the sensor data in the second direction and the third direction.

In some aspects, the apparatus also includes a transfer system configured to receive the card carrier from a first transfer direction and provide the card carrier to the flipper system in a second transfer direction perpendicular to the first transfer direction. The sensor data is associated with the card carrier when the card carrier is positioned in the transfer system. The controller is also configured to determine, based on the sensor data, that the card carrier is positioned in the transfer system and operate the transfer system to provide the card carrier to the flipper system in the second transfer direction.

In some aspects, the transfer system also includes a plurality of intake rollers configured to move the card carrier in the first transfer direction and a plurality of outtake rollers configured to move the card carrier in the second direction. The controller is also configured to operate the plurality of intake rollers to move the card carrier in the first transfer direction prior to receiving the sensor data and operate the plurality of outtake rollers to move the card carrier in the second transfer direction after receiving the sensor data.

In some aspects, the transfer system also includes an intake actuator configured to move the plurality of intake rollers between an engagement position where the plurality of intake rollers are configured to engage the card carrier and a disengagement position where the plurality of intake rollers are configured to not engage the card carrier and an outtake actuator configured to move the plurality of outtake rollers between the engagement position where the plurality of outtake rollers are configured to engage the card carrier and the disengagement position where the plurality of outtake rollers are not configured to engage the card carrier. The controller is also configured to operate the intake actuator to position the plurality of intake rollers in the engagement position and operate the outtake actuator to position the plurality of outtake rollers in the disengagement position prior to operating the plurality of intake rollers to move the card carrier in the first transfer direction and operate the intake actuator to position the plurality of intake rollers in the disengagement position and operate the outtake actuator to position the plurality of outtake rollers in the engagement position prior to operating the plurality of outtake rollers to move the card carrier in the second transfer direction.

In some aspects, the controller is also configured to operate the outtake actuator to position the plurality of outtake rollers in the engagement position prior to receiving the sensor data.

In some aspects, the transfer system is configured to receive the card carrier from a printer. The controller is also configured to operate the printer to print the card carrier based on the one or more inputs.

In some aspects, the one or more inputs further comprise at least one of a material of the card carrier, a size of the card carrier, a thickness of the card carrier, or a type of the card carrier.

In some aspects, the apparatus also includes a buffer system configured to store a plurality of card carriers, the buffer system configured to provide the card carrier to the transfer system in the first transfer direction. Responsive to determining that a previous card carrier has been provided from the transfer system to the flipper system, the controller is further configured to operate the buffer system to provide the card carrier to the transfer system in the first transfer direction.

In some aspects, the buffer system is configured to receive the card carrier from a printer. The controller is also configured to operate the printer to print the card carrier based on the one or more inputs.

In some aspects, the at least one flipper arm comprise a venturi configured to provide suction to engage the card carrier for flipping the card carrier onto the conveyor.

In some aspects, the at least one flipper arm is configured to engage the downward facing surface of the card carrier prior to flipping the card carrier and disengage from the upward facing surface after flipping the card carrier

In some aspects, the flipper system further includes a plurality of intake rollers configured to move the card carrier in the second direction. The controller is also configured to operate the plurality of intake rollers to move the card carrier in the second direction prior to operating the at least one flipper arm to engage the card carrier.

In some aspects, the flipper system also includes an intake actuator configured to move the plurality of intake rollers between an engagement position where the plurality of intake rollers are configured to engage the card carrier and a disengagement position where the plurality of intake rollers are configured to not engage the card carrier. The controller is also configured to operate the intake actuator to position the plurality of intake rollers in the engagement position prior to operating the plurality of intake rollers to move the card carrier in the second direction and operate the intake actuator to position the plurality of intake rollers in the disengagement position after operating the at least one flipper arm to engage the card carrier but prior to operating the at least one flipper arm to flip the card carrier onto the conveyor.

In some aspects, the flipper system further includes a flipper conveyor configured to move the card carrier in the second direction. The controller is also configured to operate the flipper conveyor to move the card carrier in the second direction prior to operating the at least one flipper arm to engage the card carrier.

Aspects of the present invention are directed to a method including receiving, by a controller of a card attachment system, one or more inputs comprising at least a desired location on a card carrier where a transaction card is to be affixed and a desired orientation of the transaction card on the card carrier, wherein the card carrier is transported by a conveyor in a first direction towards a gantry of the card attachment system, operating, by the controller, a printer to print the card carrier, determining, by the controller, that the card carrier has been received by a flipper system from the printer, the flipper system comprising at least one flipper arm configured to engage the card carrier and flip the card carrier onto the conveyor, wherein the at least one flipper arm is configured to flip the card carrier such that a downward facing surface of the card carrier becomes an upward facing surface, operating, by the controller, the at least one flipper arm to engage the card carrier and flip the card carrier onto the conveyor, moving, by the controller, an arm of the gantry based on the one or more inputs in a second direction perpendicular to the first direction and in a third direction perpendicular to the first direction and the second direction, and affixing, by the controller, the transaction card to the card carrier using the arm.

In some aspects, wherein prior to operating the at least one flipper arm to engage the card carrier, the method also includes receiving, from a sensor system, sensor data associated with the card carrier and determining, based on the sensor data, that the card carrier has been received by the at least one flipper arm.

Aspects of the present invention include a non-transitory, computer-readable medium including computer-readable instructions which, when executed by a processor, cause the processor to receive one or more inputs comprising at least a desired location on a card carrier where a transaction card is to be affixed and a desired orientation of the transaction card on the card carrier, wherein the card carrier is transported by a conveyor in a first direction towards a gantry of a card attachment system, operate a printer to print the card carrier, determine that the card carrier has been received by a flipper system from the printer, the flipper system comprising at least one flipper arm configured to engage the card carrier and flip the card carrier onto the conveyor, wherein the at least one flipper arm is configured to flip the card carrier such that a downward facing surface of the card carrier becomes an upward facing surface, operate the at least one flipper arm to engage the card carrier and flip the card carrier onto the conveyor, move an arm of the gantry based on the one or more inputs in a second direction perpendicular to the first direction and in a third direction perpendicular to the first direction and the second direction, and affix the transaction card to the card carrier using the arm.

In some aspects, the instructions cause the controller to receive, from a sensor system, sensor data associated with the card carrier and move the arm of the gantry based on the sensor data in the second direction and the third direction.

### BRIEF DESCRIPTION OF THE DRAWINGS

FIG. 1 is a perspective view of a portion of an example card attachment system for attaching a card to a card carrier, in accordance with one or more embodiments.

FIG. 2 is another perspective view of a portion of the example card attachment system of FIG. 1, in accordance with one or more embodiments.

FIG. 3 is a perspective view of an example gantry of the example card attachment system of FIG. 1 that attaches the card to the card carrier, in accordance with one or more embodiments.

FIG. 4 is another perspective view of the example gantry of FIG. 3, in accordance with one or more embodiments.

FIG. 5 is an example stager configured to position cards for attachment in the card attachment system of FIG. 1, in accordance with one or more embodiments.

FIG. 6 is an example taper configured to apply adhesive to cards for attachment in the card attachment system of FIG. 1, in accordance with one or more embodiments.

FIG. 7 is an example positioner configured to position carriers for folding in the card attachment system of FIG. 1, in accordance with one or more embodiments.

FIG. 8 is a perspective view of an example printing system of the example card attachment system of FIG. 1 that prints the card carrier, in accordance with one or more embodiments.

FIG. 9 is a perspective view of a portion of the printing system of FIG. 8, in accordance with one or more embodiments.

FIG. 10 is another perspective view of the printing system of FIG. 8, in accordance with one or more embodiments.

FIG. 11 is another perspective view of a portion of the printing system of FIG. 8, in accordance with one or more embodiments.

FIG. 12 is another perspective view of a portion of the printing system of FIG. 8, in accordance with one or more embodiments.

FIG. 13 is an example flowchart illustrating a process for attaching the card to the carrier using the card attachment system of FIG. 1, in accordance with one or more embodiments.

FIG. 14 is an example block diagram illustrating a card attachment system such as the card attachment system of FIG. 1, in accordance with one or more embodiments.

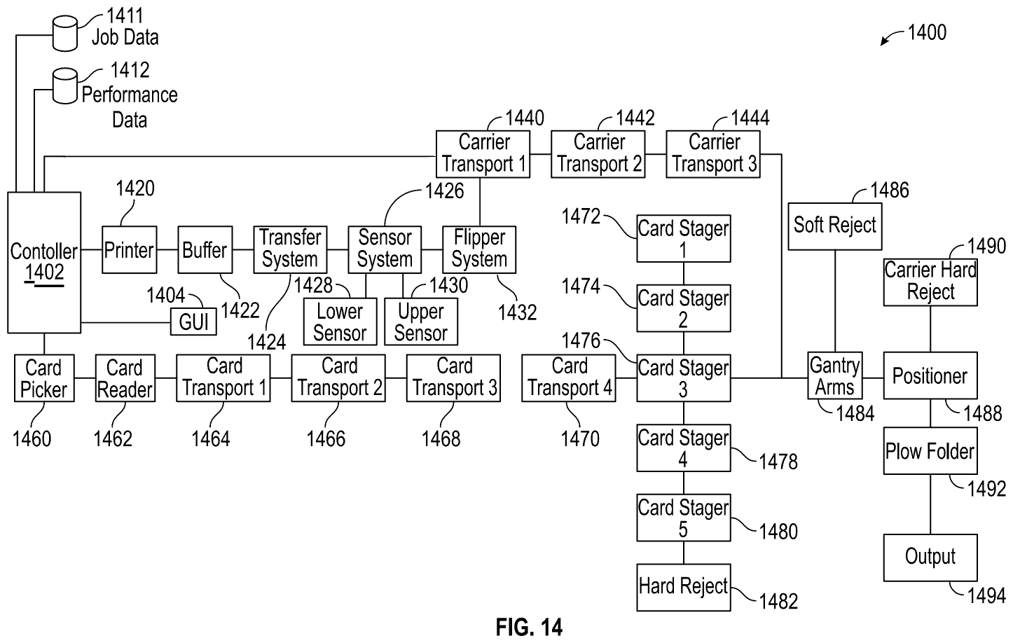

FIG. 15 is an example block diagram of a computing system implementing a card attachment application for the card attachment system of FIG. 1, in accordance with one or more embodiments.

The foregoing and other features of the present disclosure will become apparent from the following description and appended claims, taken in conjunction with the accompanying drawings. Understanding that these drawings depict only several embodiments in accordance with the disclosure and are therefore, not to be considered limiting of its scope, the disclosure will be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### I. Overview

The present disclosure is directed to a card attachment system that is configured to attach a card (e.g., a transaction card such as a credit card) to a card carrier (e.g., paper). The card attachment system disclosed herein provides several technical solutions and improvements over conventional systems. For example, the card attachment system includes a printing system configured to print the card carrier prior to attaching the cart to the card carrier, providing the technical improvement of reducing a number of separate systems needed to run the card attachment system.

The card attachment system also solves the technical problem of how to orient the card carriers in a desired orientation that enables the card attachment system to attach the cards to the card carriers. For example, the card attachment system includes a flipper system configured to flip the card carriers before the card is affixed to the card carrier. The flipper system may be configured to flip the card carrier such that a downward facing surface of the card carrier becomes an upward facing surface of the card carrier and an upward facing surface of the card carrier becomes a downward facing surface of the card carrier. The flipper system may allow for the card attachment system to flip the card carriers when it is desired to affix the card to a surface of the card carrier that is a downward facing surface such that the surface becomes an upward facing surface that the card may be affixed to.

### II. Overview of Card Attachment System

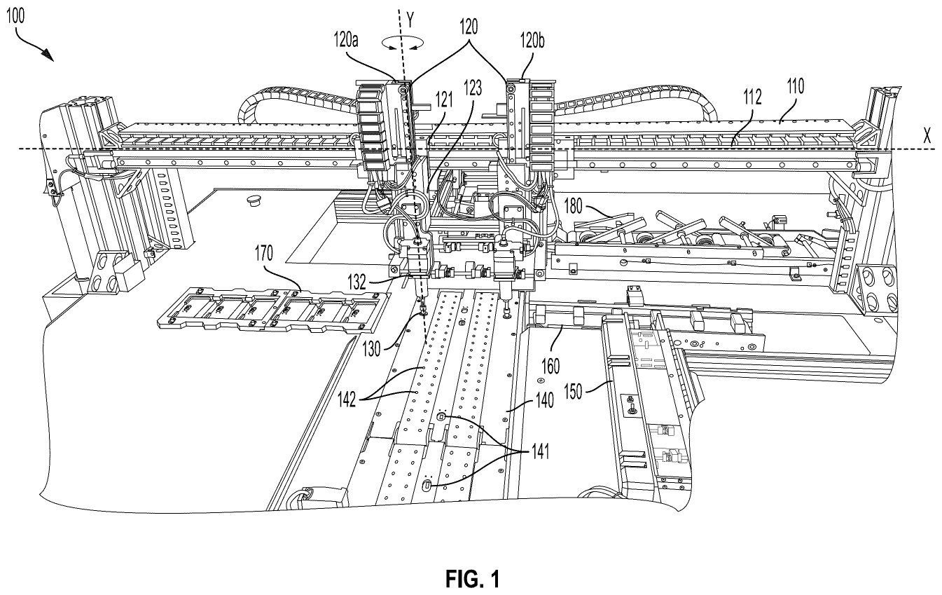

FIG. 1 is a perspective view of an example card attachment system 100 for attaching a card to a card carrier, in accordance with one or more embodiments. The card attachment system 100 may be similar to the card attachment systems 100 as described in greater detail in U.S. application Ser. No. 17/951,406, filed Sep. 23, 2022, U.S. application Ser. No. 17/951,425, filed Sep. 23, 2022, and/or U.S. application Ser. No. 17/951,417, filed Sep. 23, 2022, the entire disclosures of which are incorporated by reference herein.

The card attachment system 100 may include a gantry 110 including one or more arms 120 attached to the gantry 110. The one or more arms 120 may include a first arm 120a and a second arm 120b. The first arm 120a and the second arm 120b may be identical or symmetrical to one another. Features discussed herein relative to the first arm 120a apply to the second arm 120b. The first arm 120a may include one or more motors which enable the first arm 120a to move along multiple axes. The first arm 120a may include a first motor 121 configured to move the first arm 120a along a horizontal axis X. The first arm 120a may be configured to move along the horizontal axis X along a rail 112 of the gantry 110. The first arm 120a may include a second motor 123 configured to move the first arm along the vertical axis Y. In some embodiments, the one or more arms 120 may include more than two arms.

The first arm 120a may include a cup 130 configured to apply suction to the card (not shown in FIG. 1). For example, the first arm 120a may include a venturi configured to provide suction to the cup 130 to pick up the card. Each arm may include a rotation motor 132 configured to rotate the cup 130 about the vertical axis Y. The rotation motor 132 may be configured to rotate the cup 130 to an orientation accurate to within 5°. The rotation motor 132 may be configured to rotate the cup 130 to any rotational orientation. The rotation motor 132 may include an encoder configured to track rotation of the cup 130. The card may be a transaction card such as a credit card, a debit card, a gift card, a health care card, a payroll debit credit card, a gift card or any personalized or non-personalized type of transactional card, a wearable device that may or may not be personalized, or any other planar object. In some embodiments, the card may be a non-personalized device merged with a personalized device or other RF device such as a wearable transaction device.

The card attachment system 100 may include a conveyor 140 along which card carriers travel towards the gantry 110. The conveyor 140 may move the card carriers along the conveyor 140. The conveyor 140 may include one or more holes 142. One or more fans below the conveyor 140 may generate a pressure differential configured to suction the card carriers to the conveyor 140 as the card carriers are moved by the conveyor 140. The conveyor 140 may include one or more sensors 141 configured to determine carrier identifiers of the card carriers as the card carriers move along the conveyor 140. A carrier identifier may be a unique identifier of the card carrier which allows a controller to identify the card carrier and track the card carrier as it is moved by the conveyor 140. Examples of card carriers include papers, booklets, or box products. The card carriers may be any product configured to receive the card or other instrument. The card carrier may be configured to receive the card.

A card reader 150 of the card attachment system 100 may be configured to determine card identifiers of cards. The card reader 150 may be configured to move the card to a stager 160. The stager 160 may include a plurality of compartments, where each compartment is configured to hold a card such that the cup 130 of an arm of the one or more arms 120 can pick up the card and place the card on the card carrier. Each compartment may be configured to receive one card, where the card has a predetermined configuration. For example, in some embodiments, each compartment may be configured to receive a rectangular card, where a long end of the card is parallel to a first end of the compartment, the card is face up, and a writing on the card is right-side up relative to the first end of the compartment. The stager 160 may be configured to move the plurality of compartments such that the card reader 150 delivers the card to a particular compartment of the plurality of compartments.

The card attachment system 100 may contain one or more soft reject areas 170. The one or more soft reject areas 170 may be configured to receive one or more cards. The one or more arms 120 may place a rejected card in the one or more soft reject areas 170 if the rejected card does not match a current card carrier, as discussed in greater detail below. The one or more arms 120 may retrieve the rejected card from the one or more soft reject areas 170 when the card matches the current card carrier. The one or more soft reject areas 170 may include one or more sensors for identifying cards.

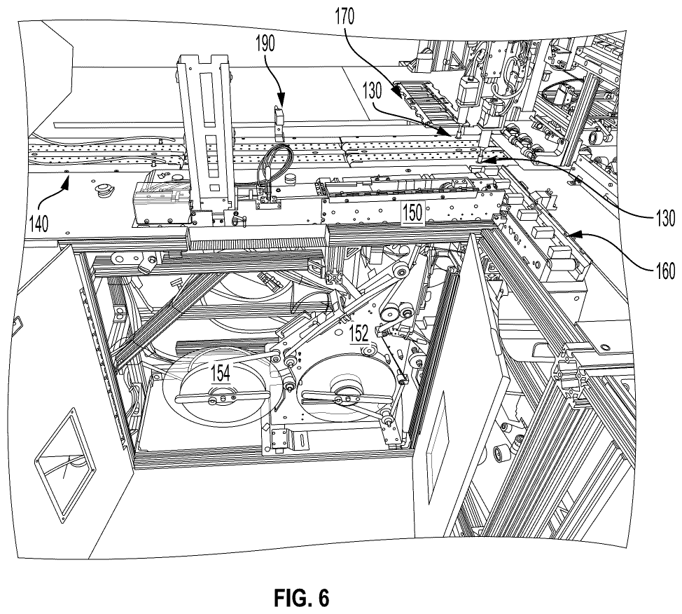

The card attachment system 100 may include a folder 180 configured to fold the card carriers. The folder 180 may also be called a folding apparatus or a first folding apparatus. In some embodiments, the folder 180 may be a plow folder. The folder 180 may be configured to fold a card carrier after one or more cards have been attached to the card carrier. The folder may be configured to fold the card carrier based on one or more inputs including a desired location on the card carrier where the card is to be affixed, a desired orientation of the card on the card carrier, a number of folds on the card carrier, and one or more fold locations on the card carrier. In other embodiments, other inputs may be used. In some embodiments, the card carrier is scored in the one or more fold locations to make the fold. The card attachment system 100 may include a second folder, as shown in FIG. 6 configured to fold the card carrier before the one or more cards have been attached to the card carrier. The folder and the second folder may be associated with one another. The folder and the second folder may be associated with one another as part of the card attachment system 100. The second folder may make one or more folds in the card carrier equal to the number of folds desired in the card carrier minus one and the folder may make a final fold in the card carrier.

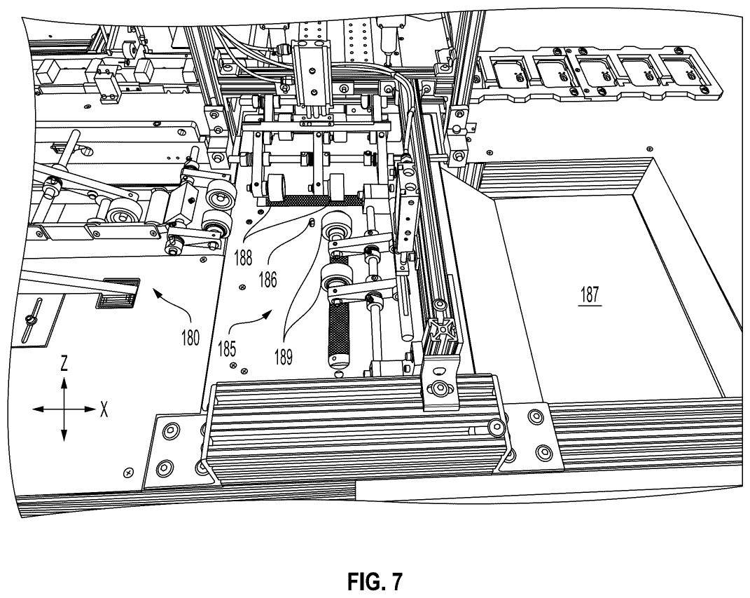

In some embodiments, the folder 180 may be configured to make a single fold in the card carrier based on a position and orientation of the card carrier as the card carrier enters the folder 180. The position and/or orientation of the card carrier as the card carrier enters the folder is controlled by a positioner, as discussed in conjunction with FIG. 7.

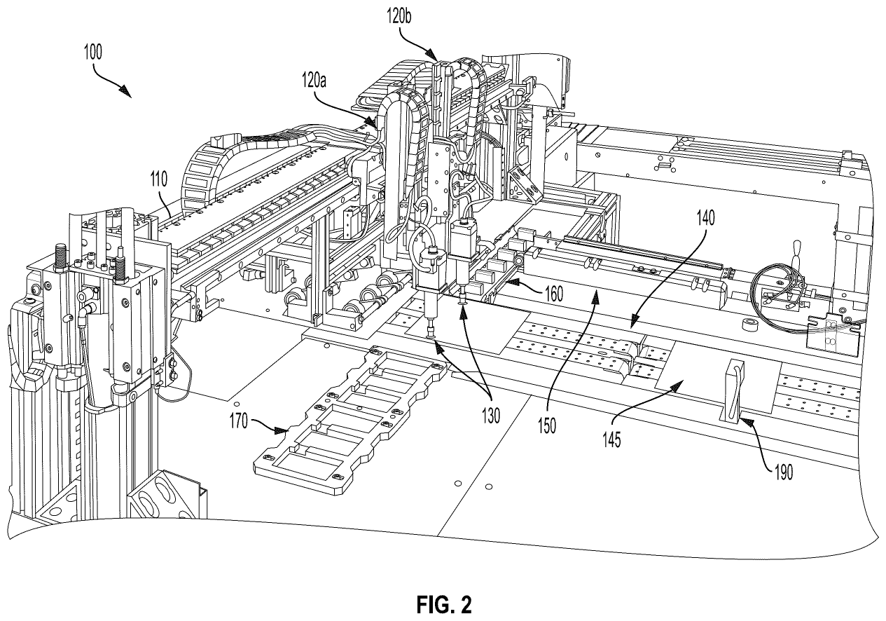

FIG. 2 is a side perspective view of the example card attachment system 100 of FIG. 1. The card attachment system 100 may include a position sensor 190. The position sensor 190 may be configured to sense a position of the card carrier 145 on the conveyor 140. The position sensor 190 may be configured to sense an edge of the card carrier 145 to determine a lateral displacement of the card carrier 145 on the conveyor 140. The lateral displacement is a measure of displacement along a horizontal axis orthogonal to the direction of movement of the card carrier 145 along the conveyor 140. The position sensor 190 may determine a rotation of the card carrier 145 on the conveyor 140. The one or more arms 120 may adjust their movement to account for the lateral displacement and/or the rotation of the card carrier 145. The one or more arms 120 may adjust their movement based on the lateral displacement from the position sensor 190 to place the card in the desired location and orientation on the card carrier. In some embodiments, the position sensor 190 may be an edge sensor. The position sensor 190 provides continuous feedback to the gantry 110 of a card carrier position on the conveyor 140 to compensate for card carrier position movement left or right on the conveyor 140 and adjusts a card placement based on this feedback to maintain consistent card placement on each card carrier.

The card reader 150 of the card attachment system 100 may be configured to determine a card identifier and deliver the card to the stager 160. The card identifier may be a unique identifier which allows a controller to identify the card and track the card. In some embodiments, the card reader 150 may determine the card identifier by scanning a magnetic strip of the card. In other embodiments, the card reader 150 may determine the card identifier by optically sensing words on the card. In yet other embodiments, the card reader 150 may determine the card identifier by sensing a near-field communication (NFC) chip of the card.

The stager 160 may include a plurality of compartments for receiving the card. The stager 160 may select a compartment of the plurality of compartments for receiving the card based on where the card is to be attached to the card carrier 145, how many cards are to be attached to the card carrier 145, a current position of the one or more arms 120, and/or a future position of the one or more arms 120. In some embodiments, the plurality of compartments may be positioned on a belt and defined by barriers on the belt. The stager 160 may select a compartment of the plurality of compartments by moving the belt such that the compartment is located adjacent the card reader 150 as the card is dispensed from the card reader 150. For example, in some embodiments, the stager 160 may receive a card in a compartment located to the right of the center of the stager 160 as viewed from the card reader 150 if a second card is to be attached to the card carrier 145 along with the card. The second card may be received by the stager 160 in a compartment located to the left of the center of the stager 160 such that a first arm and a second arm of the one or more arms 120 do not collide or otherwise interfere with one another as the first arm picks up the card and the second arm picks up the second card. In some embodiments, more than two cards may be placed on the card carrier. Any number of cards may be placed on the card carrier up to a capacity of the card carrier. In another example, the stager 160 may place successive cards in adjacent compartments such that several cards are available to the one or more arms. Placing cards in various compartments of the stager 160 to accommodate movement of the one or more arms 120 may reduce a number of movements of the one or more arms 120 required for picking up the card or cards. Reducing the number of movements required for picking up the card or cards may result in faster attachment times.

The cup 130 attached to each arm of the one or more arms may be configured to apply suction to the card to pick up the card from the stager. A level of suction or pressure may be used to determine when the card has been picked up. Each arm of the one or more arms 120 may be calibrated to a height of the card in the stager 160 by pressing the cup 130 into one or more compartments of the stager 160. Each arm of the one or more arms 120 may be calibrated to a height of the card carrier 145 on the conveyor 140 by pressing the cup 130 into the conveyor 140.

The one or more arms 120 may attach the card to the card carrier 145 if the card identifier is associated with or matches the carrier identifier. If the card identifier is not associated with or does not match the carrier identifier, the one or more arms do not attach the card to the card carrier 145. If the card identifier is associated with a card carrier 145 which has not yet passed beneath the gantry 110, the one or more arms 120 may place the card in one or more soft reject areas 170. The one or more soft reject areas may be located adjacent the conveyor 140 and may include sensors configured to determine card identifiers of cards placed in the one or more soft reject areas 170. The one or more arms may retrieve the card from the one or more soft reject areas when the card carrier 145 associated with the card identifier approaches the gantry 110 and attach the card to the card carrier 145 associated with the card identifier. If the card identifier is associated with a card carrier 145 which has already passed beneath the gantry 110, the card may be placed by the stager 160 in a hard reject area. The hard reject area may be located on a side of the stager 160 away from the conveyor 140. In some embodiments, the hard reject area is inaccessible to the one or more arms 120 and cards in the hard reject area may be retrieved by an operator of the card attachment system 100.

### III. Overview of Gantry

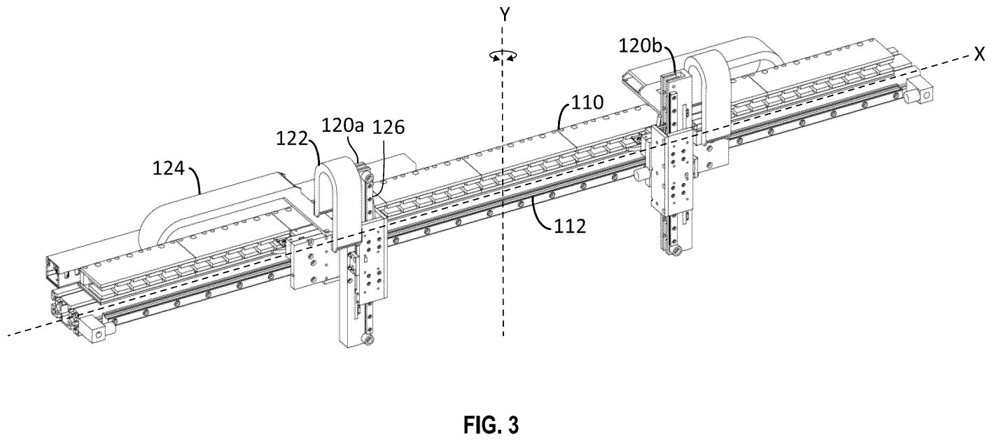

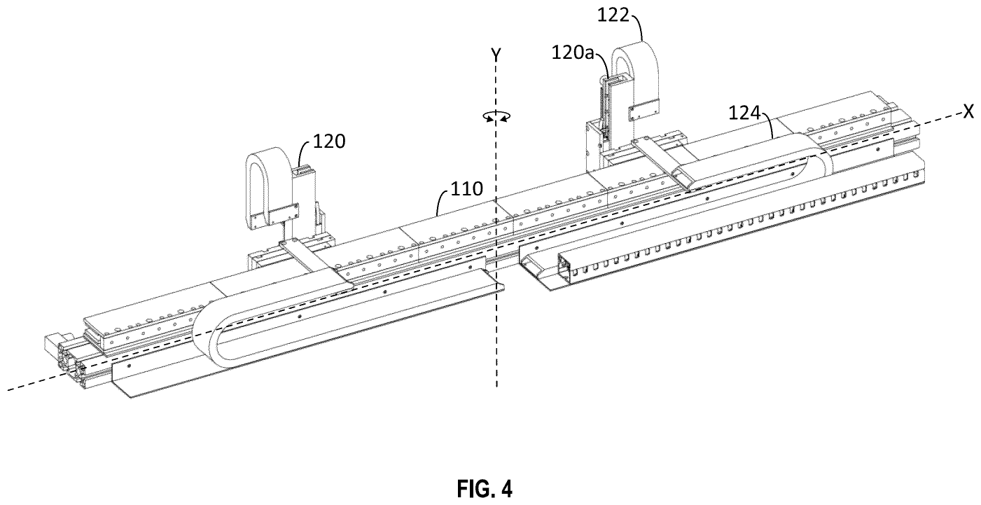

FIGS. 3 and 4 are perspective views of the gantry 110 of FIG. 1 that attaches the card to the card carrier, in accordance with one or more embodiments. The gantry 110 may include the one or more arms 120. The one or more arms 120 may include the first arm 120a and the second arm 120b. The first arm 120a may include a first wire track 122 (e.g., a vertical wire track, etc.) configured to assist the second motor 123 of FIG. 1 to move the first arm 120a along the vertical axis, Y. The first arm 120a may include a vertical rail 126 along which the components of the first arm 120a move when moving along the vertical axis Y. The first wire track 122 may allow the first arm 120a to move along the vertical axis Y through a range of, for example, about thirteen inches in some embodiments. This range of vertical motion may allow the first arm 120a to attach instruments, such as credit cards, to various card carriers (e.g., a plurality of card carriers, etc.) such as sheets of paper, booklets, and boxes. The first arm 120a may include a second wire track 124 (e.g., a horizontal wire track, etc.) configured to assist the first motor 121 to move the first arm along the horizontal axis X. The second wire track 124 may include a motor configured to move the first arm along the horizontal axis along the rail 112. The one or more arms 120 may move along the rail 112 simultaneously. The rail 112 may be a common rail on which the one or more arms 120 move. In some embodiments, the one or more arms 120 include one or more sensors to prevent the one or more arms 120 from colliding with each other. In other embodiments, the gantry 110 may include one or more sensors to prevent the one or more arms 120 from colliding with each other. A controller may receive input from the one or more sensors and stop movement of at least a first arm or a second arm of the one or more arms upon the one or more sensors detecting that the first arm and the second arm are within a predetermined distance of one another. The one or more arms 120 may each arm include a rotation motor 132 (as shown in FIG. 1) configured to rotate the cup 130 about the vertical axis Y. The rotation motor 132 may be configured to rotate the cup 130 to an orientation accurate to within 5°. The rotation motor 132 may be configured to rotate the cup 130 to any rotational orientation. The rotation motor 132 may include an encoder configured to track rotation of the cup 130.

In some embodiments, the one or more arms 120 are configured to move independently of one another. In other embodiments, the one or more arms 120 may be configured to move in tandem. In yet other embodiments, the one or more arms 120 may be configured to be connected as they move together for stability. The one or more arms 120 may move simultaneously.

In some embodiments, the first arm 120a may be configured to affix a first instrument, such as a first transaction card, to the card carrier. The second arm 120b may be configured to affix a second instrument, such as a second transaction card, to the card carrier. The first arm 120a and the second arm 120b may move independently and simultaneously to pick up the first instrument and the second instrument and place them on the card carrier. The first arm 120a and the second arm 120b may place the first and second instruments on the card carrier in any orientations. In some embodiments, the first arm 120a and the second arm 120b may place the first instrument and the second instrument on separate card carriers. The first arm 120a may pick up the first instrument and attach the first instrument to a first card carrier. The second arm 120b may pick up the second instrument and attach the second instrument to the second card carrier. In some embodiments, the first arm 120a may attach the first instrument to the first card carrier in a first orientation and the second arm 120b may attach the first instrument to the second card carrier in a second orientation. The first arm 120a and the second arm 120b may attach the first instrument to the first card carrier in the first orientation and the second instrument to the second card carrier independent of one another.

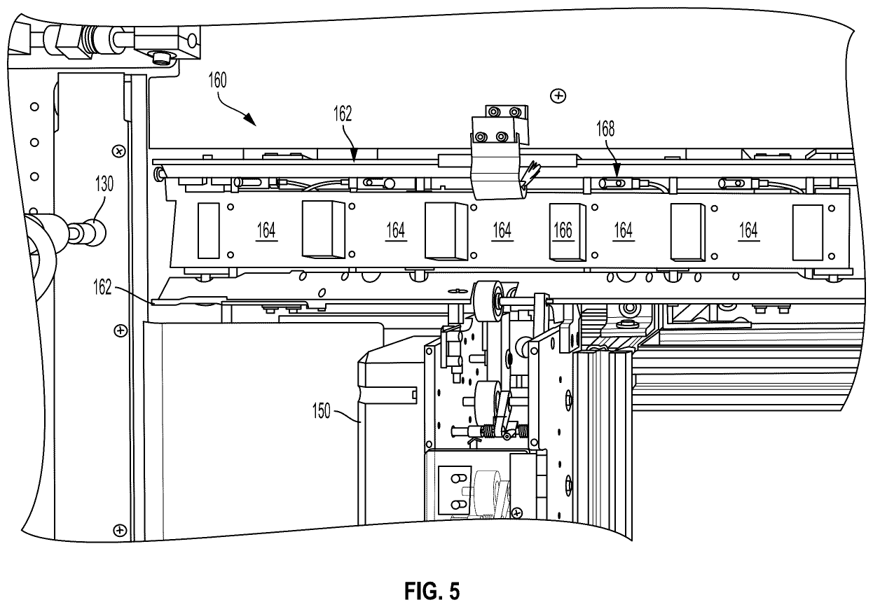

FIG. 5 is an example of the stager 160 configured to position cards for attachment in the card attachment system 100 of FIG. 1, in accordance with one or more embodiments. The stager 160 may include a plurality of compartments 164 separated by barriers 166. The number of compartments shown in FIG. 5 is merely an example number of compartments. In some embodiments, the stager 160 may include more or fewer compartments. Each of the plurality of compartments 164 may be configured to receive a card from the card reader 150. The card reader 150 may be stationary and the stager 160 may move such that the card reader places the card in a particular compartment of the plurality of compartments 164. The stager 160 may move such that the card is placed in the particular compartment based on where the card is to be attached to a card carrier 145, how many cards are to be attached to the card carrier 145, a current position of one or more arms 120, and/or a future position of the one or more arms 120, as discussed herein. The stager 160 may move such that a card in a compartment of the plurality of compartments 164 moves out of the stager 160 into a hard reject area. For example, in some embodiments, the stager may move such that a compartment in which the card is located moves around an edge of a belt of the stager, dropping the card into the hard reject area.

The stager 160 may include a plurality of rails 162 (e.g., two of the rails 162, etc.) on which the card rests while in the stager 160. The rails 162 may have a height lower than a height of the barriers 166 such that the barriers can push the card along the rails 162 as the stager 160 moves. The rails 162 may present a narrow surface area for contacting the card. The card may, in the stager 160, be in contact with only the rails 162 and the barriers 166, preventing marring or scratching of the card. In some embodiments, the card may include tape, glue, or another adhesive on a surface of the card. The tape, glue, or another adhesive may be on a center of the card such that the rails 162 do not contact the tape, glue, or another adhesive.

The stager 160 may include one or more sensors 168 configured to determine the card identifier to conveyor the card through the stager 160 and allow the cup 130 to pick up the card and attach it to the card carrier 145 associated with the card identifier. The cup 130 of the one or more arms may pick up the card using suction from the stager 160.

FIG. 6 is an example taper 152 configured to apply adhesive to cards for attachment in the card attachment system of FIG. 1, in accordance with one or more embodiments. The taper may include a tape roll 154. The taper 152 may be configured to apply tape, glue, or another adhesive to the card as the card passes through the card reader 150. The taper may apply the tape, glue, or another adhesive to a center of the card such that the tape, glue, or another adhesive does not contact the rails 162 of the stager 160 as discussed herein. The tape, glue, or another adhesive may bind the card to the card carrier. The adhesive may be applied to the card in any desired orientation.

FIG. 7 is an example positioner 185 configured to position card carriers for folding in the card attachment system 100 of FIG. 1, in accordance with one or more embodiments. The positioner may include one or more sensors 186 configured to determine a carrier identifier. The positioner 185 may be configured to direct a card carrier to a reject bin 187 or a folder 180. The positioner 185 may include first rollers 188 and second rollers 189. The first rollers 188 may be configured to position the card carrier along a Z axis perpendicular to the X and Y axes of FIG. 1. The second rollers 189 may be configured to position the card carrier along an X axis corresponding to the X axis of FIG. 1. The first rollers 188 and the second rollers 189 may contact the card carrier and move the card carrier in the X-Y plane, guided by feedback from the one or more sensors 186. The first rollers 188 and the second rollers 189 may position the card carrier in the X-Y plane before the folder 180 such that the folder 180 makes one or more folds in the card carrier according to input describing a number of folds desired in the card carrier, a location of the folds on the card carrier, and one or more directions of the folds on the card carrier. In some embodiments, the first rollers 188 may position the card carrier according to the input and the second rollers 189 may feed the card carrier to the folder 180 such that the folder 180 makes one or more folds in the card carrier according to the input.

The positioner 185 may direct the card carrier to the reject bin 187 based on the card carrier not having an attached card. The card carrier may not have an attached card because a card associated with the card carrier was not attached to the card carrier. The associated card may have not been attached to the card carrier because the card carrier arrived at the gantry 110 of the card attachment system 100 before the card was placed in the stager 160 of the card attachment system 100. In some embodiments, the positioner 185 may direct the card carrier to the reject bin 187 based on one or more defects of the card carrier. For example, in some embodiments, the card carrier may be folded improperly and/or the card may be attached to the card carrier at a wrong location or in a wrong orientation. In another example, the card carrier may lack a card due to the required card not being available when the card carrier passed beneath the gantry, as discussed above. In some embodiments, the one or more sensors 186 are configured to detect the one or more defects of the card carrier. In other embodiments, other portions of the card attachment system 100 are configured to detect the one or more defects of the card carrier and transmit a signal to the positioner 185 to direct the card carrier to the reject bin 187. In some embodiments, if there is any known issue with a card carrier, reject bin 187 will be utilized to purge the card carrier from the system without stopping the card attachment system. Issues may include that the card carrier was detected by one of the one or more sensors 186 as blocked at the wrong time or that the card carrier present at the gantry 110 does not have any cards that match the card carrier. The software will purge the card carrier from the card attachment system using the reject bin 187 while continuing to process other card carriers.

The positioner 185 may be configured to direct the card carrier to the folder 180 such that the folder 180 folds the card carrier. The positioner 185 may be configured to direct the card carrier to the folder 180 such that the folder 180 folds the card carrier according to the input describing a number of folds desired in the card carrier, a location of the folds on the card carrier, and one or more directions of the folds on the card carrier. The positioner 185 may be configured to position the card carrier before the folder 180 according to the input before directing the card carrier to the folder 180 such that the folder 180 folds the card carrier according to the input. The positioner 185, may determine where the carrier will stop based on the input or a job profile. The positioner 185 may move the carrier to where the fold line or perforation is intended to be placed and feed the carrier into the folder 180 to create a final fold in the card carrier.

In some embodiments, the card carrier is scored in a location where the folds on the card carrier are to be made. The folds made by the folder 180 in the card carrier may follow scoring on the card carrier. In some embodiments, the one or more sensors 186 may be configured to determine a location of the scoring in the card carrier for positioning the card carrier. In other embodiments, the one or more sensors 186 may be configured to retrieve information pertaining to the scoring based on determining the carrier identifier of the card carrier.

In some embodiments, the card carrier is folded one or more times before reaching the positioner 185. The card carrier may be folded one or more times by the second folder before the card is attached to the folder. The folder 180 may add an additional fold or folds to the card carrier after the card is attached to the card carrier. For example, in some embodiments, the card carrier may require 3 folds, two of which are made before the card is attached to the card carrier. A final, third fold may be made by the folder 180 when the card carrier is directed to the folder 180 by the positioner 185. The positioner 185 may position the card carrier such that the folder 180 makes the third fold in a location specified by the input.

In some embodiments, the positioner is configured to direct the card carrier past the folder 180 such that the folder 180 does not fold the card carrier based on the card carrier not needing additional folds. In other embodiments, the positioner 185 is configured to direct the card carrier past the folder 180 such that the folder 180 does not fold the card carrier based on the card carrier being a booklet or a box product.

### IV. Overview of Printer System

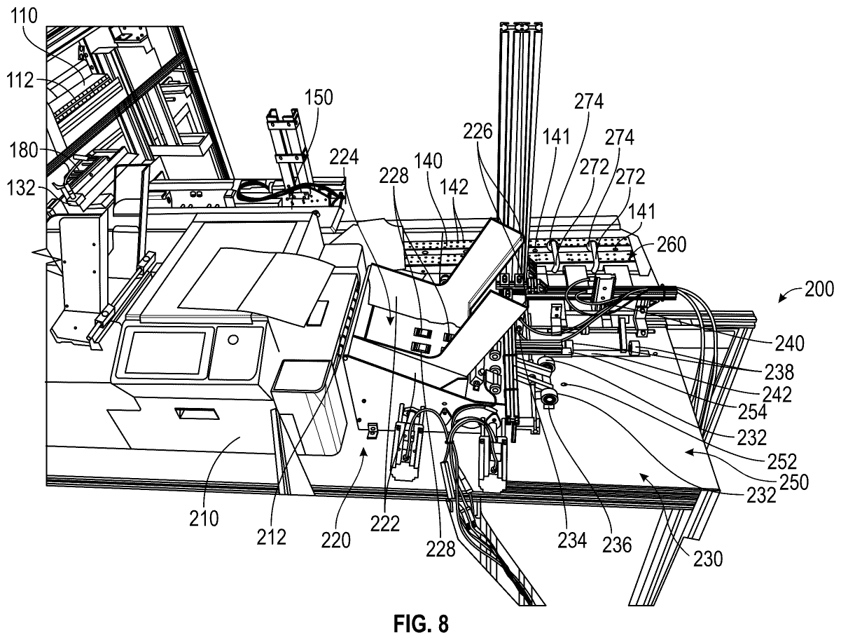

FIG. 8 is a perspective view of an example printing system 200 (e.g., a printer system, a printer assembly, a printing assembly, etc.) of the example card attachment system 100 of FIG. 1. The printing system 200 may be configured to print the card carriers that the card attachment system 100 attaches the cards to. The printing system 200 may provide the card carriers to the conveyor 140 that moves the card carriers toward the gantry 110. In some embodiments, the printing system 200 is configured to orient the card carriers in a desired orientation based on the card attachment system 100. For example, if a first surface of the card carriers is facing upward after the card carriers are printed and the desired orientation of the card carriers for the card attachment system 100 is for a second surface of the card carriers opposing the first surface of the card carriers to be facing upward, the printing system 200 may flip (e.g., turn, overturn, etc.) the card carriers such that the second surface of the card carriers face upward and the card carriers are in the desired orientation before being provided to the conveyor 140 and moved toward the gantry 110. The flipping of the card carriers may allow for surfaces that would otherwise be downward facing surfaces covered by elements of the card attachment system 100 to be upward facing surface that can be fully scanned by sensors of the card attachment system 100.

The printing system 200 may include a printer 210 configured to print the card carriers. For example, the printer 210 may be configured to print different patterns on the card carriers based on different cards that will be attached to the card carriers. In some embodiments, the printer 210 may be configured to specifically print the card carriers (e.g., a custom printer, etc.). For example, the printer 210 may be configured to print specialty shapes that are used for the card carriers. The printer 210 may be configured to cut and/or perforate the card carriers based on the desired final orientation of the card carriers. For example, if the card carriers will be folded (e.g., by the folder 180, etc.), the printer 210 may be configured to perforate a portion of the card carriers that will be folded. In other embodiments, the printer 210 is a standard printer (e.g., an off the shelf printer, etc.). For example, the printer 210 may be a M ach 6 Digital Color Inkjet Printer configured to print card carriers with multiple colors. The printer 210 includes a printer outlet 212 where the card carriers printed by the printer 210 are outputted by the printer 210. In other embodiments, the printer 210 is separate from the printing system 200. For example, the printer 210 may be configured to provide the card carriers to the printing system 200.

The printing system 200 may include a buffer system 220 (e.g., a buffer assembly, etc.) configured to align with the printer outlet 212 of the printer 210 to receive the card carriers printed by the printer 210. In some embodiments, the buffer system 220 is configured to stage (e.g., line up, store, etc.) the card carriers printed by the printer 210. For example, after the printer 210 prints one of the card carriers and outputs the card carrier through the printer outlet 212, the card carrier may be received by the buffer system 220 and stored by the buffer system 220 until other components of the printing system 200 and/or the card attachment system 100 (e.g., a subsequent assembly of the printing system 200, etc.) are ready (e.g., prepared, etc.) to receive the card carrier. By storing the card carriers outputted by the printer 210, the buffer system 220 may allow for the printer 210 to print subsequent card carriers before the prior card carriers have proceeded past the buffer system 220 in the printing system 200. In some embodiments, the buffer system 220 is configured to receive a plurality of the card carriers from the printer 210 and then separately provide each of the card carriers to a subsequent assembly of the printing system 200 and/or the card attachment system 100 (e.g., an assembly configured to receive the card carriers from the buffer system 220, etc.). once the subsequent assembly of the printing system 200 and/or the card attachment system 100 is ready to receive each of the card carriers.

The buffer system 220 may include buffer walls 222 defining a buffer channel 224 configured to contain the card carriers printed by the printer 210. The buffer walls 222 may extend upwards and be positioned on opposite sides of the card carriers when the card carriers are received by the buffer system 220 to prevent the card carriers from moving leaving the buffer channel 224 when the card carriers are received from the printer 210. In some embodiments, the buffer walls 222 are configured to prevent the card carriers from moving in a direction perpendicular to a direction of travel of the card carriers when the card carriers are received from the printer 210. For example, the buffer walls 222 may be configured as sidewalls configured to prevent the card carriers from moving sideways (e.g., perpendicular to a direction of travel of the card carriers through the buffer system 220, etc.) when the card carriers are positioned within the buffer channel 224.

Each of buffer walls 222 may include an indexing wall 226 extending into a path of the card carriers through the buffer system 220. The indexing walls 226 may be spaced upwards to allow for a single of the card carrier to pass under the indexing walls 226 at a time to the assembly component of the printing system 200 and/or the card attachment system 100. For example, the indexing walls 226 may be spaced upwards by a distance greater than a thickness of one of the card carriers but less than a thickness of two of the card carriers such that one card carrier is able to pass under the indexing walls 226 at a time. In other embodiments, the buffer walls 222 may include a single of the indexing walls 226 extending between the buffer walls 222 and spaced upwards to allow for the single of the card carriers to pass under the indexing wall 226 at a time.

The buffer system 220 may include a plurality of buffer rollers 228 (e.g., buffer wheels, etc.). The buffer rollers 228 may be configured to contact the card carriers and move the card carriers from the buffer channel 224 towards the subsequent assembly of the printing system 200. For example, the buffer rollers 228 may be configured to contact a downward facing surface of the card carriers (e.g., a bottom surface, etc.) when the card carriers are positioned within the buffer channel 224. When the buffer rollers 228 are rotated when in contact with the downward facing surface of the card carriers, the card carrier in contact with the buffer rollers 228 may move from the buffer channel 224 towards the subsequent assembly of the printing system 200.

In some embodiments, the buffer system 220 includes one or more buffer sensors (e.g., sensors, buffer assembly sensors, etc.) configured to determine the carrier identifiers of the card carriers as the card carriers move through the buffer channel 224. For example, the buffer sensors may determine the carrier identifiers of the card carriers as the buffer rollers 228 move the card carriers from the buffer channel 224 towards the subsequent assembly of the printing system 200. In other embodiments, the buffer sensors are configured to determine the carrier identifiers of the card carriers as the card carriers are received by the buffer system 220 from the printer outlet 212 of the printer 210. In various embodiments, the buffer sensors are configured to identify an orientation of the card carriers as the card carriers move through the buffer channel 224.

The printing system 200 may include a transfer system 230 (e.g., a carrier transferer, a perpendicular transfer system, a transfer assembly, etc.) configured to receive the card carriers from the buffer system 220 and provide the card carriers to a subsequent assembly of the printing system 200 and/or the card attachment system 100. For example, the transfer system 230 may receive the card carriers from the buffer system 220 and transfer the carrier cards through the transfer system 230 to the subsequent assembly of the printing system 200 and/or the card attachment system 100. In other embodiments, the transfer system 230 is configured to receive the card carriers from the printer 210 (e.g., in embodiments of the printing system 200 that do not include the buffer system 220, etc.). In some embodiments, the buffer system 220 is configured to provide one of the card carriers to the transfer system 230 after a previous card carrier (e.g., a card carrier previous to the one of the card carriers, etc.) has cleared the transfer system 230 (e.g., has been outputted by the transfer system 230, etc.).

The transfer system 230 may be configured to receive the card carriers traveling in a first transfer direction from the buffer system 220 and transfer the card carrier to the subsequent assembly of the printing system 200 in a second transfer direction. In some embodiments, the second transfer direction may be perpendicular to the first transfer direction. For example, the card carriers may travel in a first transfer direction when the card carriers are received by the transfer system 230 from the buffer system 220 and the card carriers may travel in a second transfer direction perpendicular to the first transfer direction when the card carriers are outputted by the transfer system 230 to a subsequent assembly of the printing system 200. In other embodiments, the second transfer direction may be parallel to the first transfer direction. For example, the card carriers may travel in a first transfer direction when the card carriers are received by the transfer system 230 from the buffer system 220 and the card carriers may travel in a second transfer direction parallel to the first transfer direction when the card carriers are outputted by the transfer system 230. In still other embodiments, the second transfer direction is oriented at another angle relative to the first transfer direction (e.g., a direction other than perpendicular or parallel, 30 degrees, 45 degrees, 60 degrees, etc.).

The transfer system 230 may include intake upper rollers 232 (e.g., transfer intake upper wheels, first upper wheels, first upper rollers, a plurality of intake rollers, etc.). The intake upper rollers 232 may be configured to contact the card carriers and move the card carriers in a direction away from the buffer system 220 and towards the transfer system 230. For example, the intake upper rollers 232 may be wheels configured to contact an upward facing surface of the card carriers (e.g., a top surface, etc.) when the card carriers are being provided from the buffer system 220 to the transfer system 230. When the intake upper rollers 232 are rotated when in contact with the upward facing surface of the card carriers, the card carrier in contact with the intake upper rollers 232 may move in the direction away from the buffer system 220 and towards the transfer system 230. The intake upper rollers 232 may be configured to move the card carriers in the first transfer direction away from the buffer system 220 and towards the transfer system 230.

The transfer system 230 may include a transfer intake upper actuator 234 (e.g., an intake actuator, etc.) configured to move (e.g., actuate, etc.) the intake upper rollers 232 between a lowered position (e.g., a first position, an engagement position, etc.) where the intake upper rollers 232 are configured to contact the card carriers and a raised position (e.g., a second position, a disengagement position, etc.) where the intake upper rollers 232 are configured to not contact the card carriers. For example, the intake upper rollers 232 may be positioned lower in the lowered position than in the raised position, such that the intake upper rollers 232 may contact the card carriers in the lowered position and not contact the card carriers in the raised position. By moving the intake upper rollers 232 to the raised position where the intake upper rollers 232 do not contact the card carriers, the card carriers may be moved by other components of the transfer system 230 in directions other than the first transfer direction that the card carriers are moved in by the transfer intake upper rollers 232.

The transfer intake upper actuator 234 may be configured as a linear actuator. For example, the transfer intake upper actuator 234 may be a pneumatic linear actuator configured to be actuated by pressurized air to move the intake upper rollers 232 from the lowered position where the intake upper rollers 232 may contact the card carriers to the raised position where the intake upper rollers 232 may not contact the card carriers. In other embodiments, the transfer intake upper actuator 234 may be configured as a different type of actuator (e.g., a rotational actuator, etc.).

The transfer system 230 may include an intake lower roller 236 (e.g., transfer intake lower wheels, first lower rollers, first lower wheels, etc.). The intake lower roller 236 may be configured to contact the card carriers and move the card carriers in a direction away from the buffer system 220 and towards the transfer system 230. For example, the intake lower roller 236 may be a roller configured to contact the downward facing surface of the card carriers (e.g., a bottom surface, etc.) when the card carriers are being provided from the buffer system 220 and into the transfer system 230. When the intake lower roller 236 is rotated when in contact with the downward facing surface of the card carriers, the card carrier in contact with the intake lower roller 236 may move in the direction away from the buffer system 220 and towards the transfer system 230.

The intake lower roller 236 may be configured to move the card carriers in the first transfer direction away from the buffer system 220 and towards the transfer system 230. In some embodiments, the intake upper rollers 232 and the intake lower roller 236 are configured to cooperatively move the card carriers in the first transfer direction away from the buffer system 220 and towards the transfer system 230. For example, when the card carriers are positioned between the intake upper rollers 232 and the intake lower roller 236, the intake upper rollers 232 may contact the upward facing surface of the card carriers and rotate in a first rotating direction to move the card carrier in the first transfer direction and the intake lower roller 236 may contact the downward facing surface of the card carrier and rotate in a second rotating direction opposite the first rotating direction to move the card carrier in the first transfer direction. In various embodiments, the intake upper rollers 232 may contact the intake lower roller 236 when the intake upper rollers 232 are in the lowered position and one of the card carriers is not positioned between the intake upper rollers 232 and the intake lower roller 236.

The transfer system 230 may outtake upper rollers 238 (e.g., transfer outtake upper wheels, second upper wheels, second upper rollers, a plurality of outtake rollers, etc.). The outtake upper rollers 238 may be configured to contact the card carriers and move the card carriers in a direction away from the transfer system 230 and towards a subsequent assembly of the printing system 200 and/or the card attachment system 100. For example, the outtake upper rollers 238 may be wheels configured to contact the upward facing surface of the card carriers when the card carriers are provided from the transfer system 230 to the subsequent assembly of the printing system 200. When the outtake upper rollers 238 are rotated when in contact with the upward facing surface of the card carriers, the card carrier in contact with the outtake upper rollers 238 may move in the direction away from the transfer system 230 and towards the subsequent assembly of the printing system 200. The outtake upper rollers 238 may be configured to move the card carriers in the second transfer direction away from the transfer system 230 and towards the subsequent assembly of the printing system 200 that is perpendicular to the first transfer direction that the intake upper rollers 232 and the intake lower rollers 236 are configured to move the card carrier.

The transfer system 230 may include a transfer outtake upper actuator 240 (e.g., an outtake actuator, etc.) configured to move (e.g., actuate, etc.) the outtake upper rollers 238 between a lowered position (e.g., a first position, etc.) where the outtake upper rollers 238 are configured to contact the card carriers and a raised position (e.g., a second position, etc.) where the outtake upper rollers 238 are configured to not contact the card carriers. For example, the outtake upper rollers 238 in the lowered position may be positioned lower than in the raised position, such that the outtake upper rollers 238 may contact the card carriers in the lowered position and not contact the card carriers in the raised position. By moving the outtake upper rollers 238 to the raised position where the outtake upper rollers 238 do not contact the card carriers, the card carriers may be moved by other components of the transfer system 230 (e.g., the transfer intake upper rollers 232, the intake lower roller 236, etc.) in directions other than the second transfer direction that the card carriers are moved in by the transfer outtake upper rollers 238. For example, when the intake upper rollers 232 and the intake lower roller 236 move the card carrier in the first transfer direction away from the buffer system 220 and towards the transfer system 230, the transfer outtake upper actuator 240 may position the outtake upper rollers 238 in the raised position such that the card carrier may move under the outtake upper rollers 238 without the card carrier contacting the transfer outtake upper roller 238. Then, when the outtake upper rollers 238 move the card carrier in the second transfer direction away from the transfer system 230 and towards the subsequent assembly of the printing system 200, the transfer outtake upper actuator 240 may position the outtake upper rollers 238 in the first position such that the outtake upper rollers 238 contact the card carriers and the transfer intake upper actuator 234 may position the transfer intake upper roller 232 in the raised position such that the card carrier may be moved by the outtake upper rollers 238 out from under the intake upper rollers 232 without the card carrier being in contact with the transfer intake upper rollers 232.

The transfer outtake upper actuator 240 may be configured as a linear actuator. For example, the transfer outtake upper actuator 240 may be a pneumatic linear actuator configured to be actuated by pressurized air to move the outtake upper rollers 238 from the lowered position where the outtake upper rollers 238 may contact the card carriers to the raised position where the outtake upper rollers 238 may not contact the card carriers. In other embodiments, the transfer outtake upper actuator 240 may be configured as a different type of actuator (e.g., a rotational actuator, etc.).

The transfer system 230 may include an outtake lower roller 242 (e.g., transfer outtake lower wheel, second lower roller, second lower wheel, etc.). The outtake lower roller 242 may be configured to contact the card carriers and move the card carriers in the direction away from the transfer system 230 and towards the subsequent assembly of the printing system 200. For example, the outtake lower roller 242 may be a roller configured to contact the downward facing surface of the card carriers when the card carriers are provided from the transfer system 230 to the subsequent assembly of the printing system 200. When the outtake lower roller 242 is rotated when in contact with the downward facing surface of the card carriers, the card carrier in contact with the outtake lower roller 242 may move in the direction away from the transfer system 230 and towards the subsequent assembly of the printing system 200.

The outtake lower roller 242 may be configured to move the card carriers from the transfer system 230 to the subsequent assembly of the printing system 200 in the second transfer direction. In some embodiments, the outtake upper rollers 238 and the outtake lower roller 242 are configured to cooperatively move the card carriers from the transfer system 230 to the subsequent assembly of the printing system 200 in the second transfer direction. For example, when the card carriers are positioned between the outtake upper rollers 238 and the outtake lower roller 242, the outtake upper rollers 238 may contact the upward facing surface of the card carriers and rotate in a first transfer direction to move the card carrier in the second transfer direction and the outtake lower roller 242 may contact the downward facing surface of the card carrier and rotate in a second transfer direction opposite the first transfer direction to move the card carrier in the second transfer direction. In various embodiments, the outtake upper rollers 238 may contact the outtake lower roller 242 when the outtake upper rollers 238 are in the first position and one of the card carriers is not positioned between the outtake upper rollers 238 and the outtake lower roller 242.

The printing system 200 may include a sensor system 250 (e.g., a scanner bed, etc.), according to some embodiments. In some embodiments, the sensor system 250 may generate sensor data associated with the card carriers when the card carriers are positioned within the transfer system 230 between when the intake upper rollers 232 and the intake lower rollers 236 transfer the card carriers from the buffer system 220 to the transfer system 230 and when the outtake upper rollers 238 and the outtake lower rollers 242 transfer the card carriers from the transfer system 230 to the subsequent assembly of the printing system 200. In other embodiments, the sensor system 250 generates the sensor data associated with the card carriers when the card carriers are otherwise positioned within the printing system 200. For example, the sensor system 250 may generate the sensor data when the card carriers are positioned within the buffer system 220.

The sensor system 250 may include one or more lower sensors 252 (e.g., a lower transfer scanner, a first sensor, etc.) positioned below the card carriers when the card carriers pass the lower sensors 252. The lower sensors 252 may be configured to determine the carrier identifiers of the card carriers when the card carriers are positioned over the lower sensors 252. For example, the lower sensor 252 may be oriented towards an opening in a surface of the transfer system 230 such the downward facing surface of the card carrier is positioned in front of the lower sensor 252 when the card carrier is positioned the surface of the transfer system 230. In some embodiments, the lower sensor 252 may determine the carrier identifiers of the card carriers based on the downward facing surface of the card carriers positioned over the lower sensors 252.

The transfer system 230 may include one or more upper sensors 254 (e.g., an upper transfer scanner, a second scanner, etc.) positioned above the card carriers when the card carriers pass the upper sensors 254. The upper sensors 254 may be configured to determine the carrier identifiers of the card carriers when the card carriers pass the upper transfer sensors. For example, the upper sensor 254 may be positioned on an arm extending over the surface of the transfer system 230 such that the upward facing surface of the card carrier is positioned in front of the upper sensor 254 when the card carrier is positioned on the surface of the transfer system 230. In some embodiments, the upper sensor 254 may determine the carrier identifiers of the card carriers based on the upward facing surface of the card carriers positioned in front of the upper sensor 254. In various embodiments, the lower sensor 252 and the upper sensor 254 may cooperatively determine the carrier identifiers of the card carriers based on the upward facing surface and the downward facing surface of the card carriers.

In some embodiments, when the lower sensor 252 and/or the upper sensor 254 is making a sensor reading of the card carrier positioned on the surface of the transfer system 230, the intake upper rollers 232 and the outtake upper rollers 238 may both be in the first position and be contacting the card carrier. For example, once the card carrier has been moved onto the surface of the transfer system 230 from the buffer system 220 by the intake upper rollers 232 and the intake lower roller 236 in the first transfer direction, the outtake upper actuator 240 may move the outtake upper roller 238 from the raised position to the lowered position to contact the card carrier. The intake upper rollers 232 and the outtake upper rollers 238 may remain in the lowered position and in contact with the card carrier while the lower sensor 252 and/or the upper sensor 254 is making the sensor reading of the card carrier to prevent movement of the card carrier. Once the lower sensor 252 and/or the upper sensor 254 has completed the sensor reading, the intake upper actuator 234 may move the intake upper rollers 232 to the raised position such that the outtake upper rollers 238 and the outtake lower roller 242 may move the card carrier from the surface of the transfer system 230 to the subsequent assembly of the printing system 200 in the second transfer direction.

The printing system 200 may include a flipper system 260 (e.g., a flipping assembly, a rotating assembly, an inverter assembly, etc.) configured to receive the card carriers from the transfer system 230 in a first orientation and provide the card carriers to the conveyor 140 in a second orientation that is inverted (e.g., upside down, etc.) from the first orientation. For example, the flipper system 260 may receive the card carriers from the transfer system 230, invert the card carriers such that an upward facing surface of the card carriers becomes a downward facing surface and a downward facing surface of the card carriers becomes an upward facing surface, and provide the card carrier onto the conveyor 140 such that the card carriers can be transported to the gantry 110. In other embodiments, the flipper system 260 is configured to receive the card carriers from the printer 210 (e.g., in embodiments of the printing system 200 that do not include the buffer system 220 or the transfer system 230, etc.) or to receive the card carriers from the buffer system 220 (e.g., in embodiments of the printing system 200 that do not include the transfer system 230, etc.). In other embodiments, the sensor system 250 generates the sensor data associated with the card carriers when the card carriers are positioned within the transfer system 230.

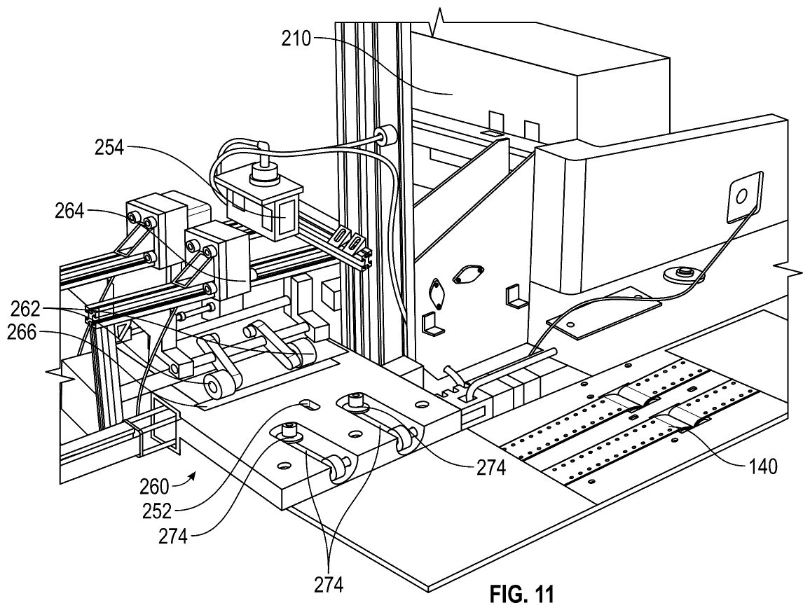

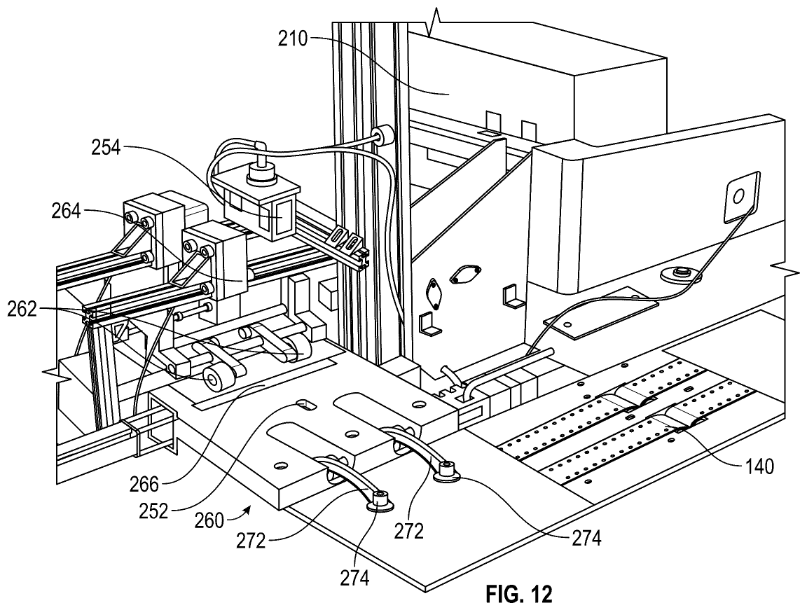

As shown in FIGS. 11 and 12, the flipper system 260 includes flipper upper rollers 262 (e.g., flipper upper wheels, third upper wheels, third upper rollers, etc.), according to some embodiments. The flipper upper rollers 262 may be configured to contact the card carriers and move the card carriers in a direction away from the transfer system 230 and towards the flipper system 260. For example, the flipper upper rollers 262 may be wheels configured to contact the upward facing surface of the card carriers when the card carriers are provided from the transfer system 230 to the flipper system 260. When the flipper upper rollers 262 are rotated when in contact with the upward facing surface of the card carriers, the card carrier in contact with the flipper upper rollers 262 may move in the direction away from the transfer system 230 and towards the flipper system 260. The flipper upper rollers 262 may be configured to move the card carriers in the second transfer direction away from the transfer system 230 and towards the flipper system 260 that is perpendicular to the first transfer direction of the card carrier between the buffer system 220 and the transfer system 230.

As shown in FIGS. 11 and 12, the flipper system 260 may include a flipper upper actuator 264 configured to move (e.g., actuate, etc.) the flipper upper rollers 262 between a lowered position (e.g., a first position, etc.) where the flipper upper rollers 262 are configured to contact the card carriers and a raised position (e.g., a second position, etc.) where the flipper upper rollers 262 are configured to not contact the card carriers, according to some embodiments. For example, the flipper upper rollers 262 in the lowered positioned may be positioned lower than in the raised position, such that the flipper upper rollers 262 may contact the card carriers in the lowered position and not contact the card carriers in the raised position. By moving the flipper upper rollers 262 to the raised position where the flipper upper rollers 262 do not contact the card carriers, the card carriers may be moved by other components of the flipper system 260 in directions other than the second transfer direction that the card carriers are moved in by the flipper upper rollers 262. For example, when the flipper upper rollers 262 are in the raised position, the card carriers may be flipped onto the conveyor 140.

The flipper upper actuator 264 may be configured as a linear actuator. For example, the flipper upper actuator 264 may be a pneumatic linear actuator configured to be actuated by pressurized air to move the flipper upper rollers 262 from the lowered position where the flipper upper rollers 262 may contact the card carriers to the raised position where the flipper upper rollers 262 may not contact the card carriers. In other embodiments, the flipper upper actuator 264 may be configured as a different type of actuator (e.g., a rotational actuator, etc.).

As shown in FIGS. 11 and 12, the flipper system 260 may include a flipper lower roller 266 (e.g., a flipper lower wheel, a third lower roller, a third lower wheel, etc.). The flipper lower roller 266 may be configured to contact the card carriers and move the card carriers in the direction away from the transfer system 230 and towards the flipper system 260. For example, the flipper lower roller 266 may be a roller configured to contact the downward facing surface of the card carriers when the card carriers are provided from the transfer system 230 to the flipper system 260. When the flipper lower roller 266 is rotated when in contact with the downward facing surface of the card carriers, the card carrier in contact with the flipper lower roller 266 may move in the direction away from the transfer system 230 and towards the flipper system 260.

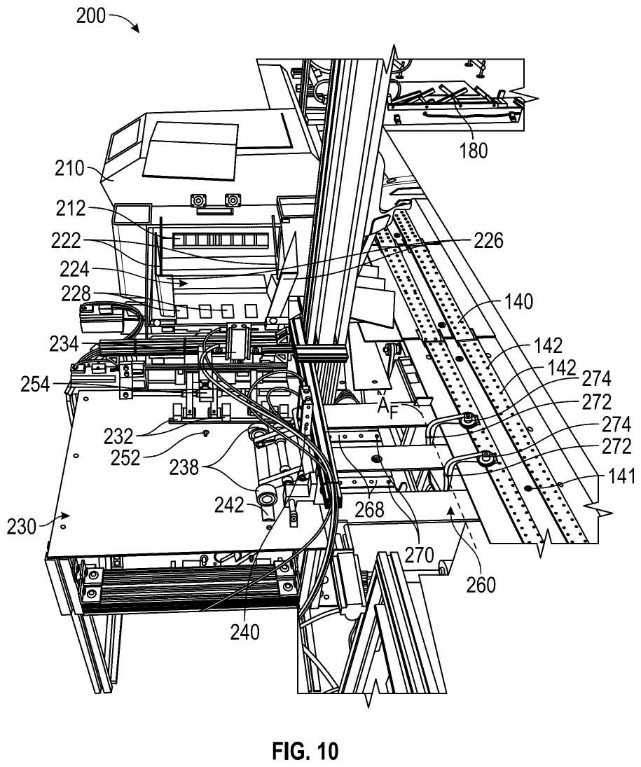

As shown in FIG. 10, the flipper system 260 may include a plurality of flipper conveyors 268, according to some embodiments. The flipper conveyor 268 may move the card carriers along the flipper conveyor 268 in the direction away from the transfer system 230 and towards the flipper system 260. The flipper conveyor 268 may include one or more flipper conveyor holes 270. One or more fans below the flipper conveyor 268 may generate a pressure differential configured to suction the card carriers to the flipper conveyor 268 as the card carriers are moved by the flipper conveyor 268. The fans may be the same fans utilized to generate the pressure differential for the conveyor 140 or different fans. In other embodiments, the flipper system 260 may include one of the flipper conveyors 268.

The flipper system 260 may include a plurality of flipper arms 272 (e.g., pivot arms, turning arms, etc.) configured to engage the card carriers and flip the card carriers such that an upward facing surface of the card carriers becomes a downward facing surface, and a downward facing surface of the card carriers becomes an upward facing surface. For example, the flipper arms 272 may engage the card carriers and rotate the card carriers around an axis parallel to a surface plane of the car carriers to flip the card carriers over. In other embodiments, the flipper system 260 includes one of the flipper arms 272 configured to engage the card carriers (e.g., at least one flipper arm, etc.). The card carriers may be positioned in an engagement position where the flipper arms 272 may engage the card carriers. For example, the flipper conveyors 268 may move the card carriers into the engagement position such that the flipper arms 272 may engage the card carriers. As another example, the flipper upper rollers 262 and/or the flipper lower rollers 266 may move the card carriers into the engagement position such that the flipper arms 272 may engage the card carriers.

The flipper arms 272 may be configured to transfer the card carriers from the flipper system 260 to the conveyor 140 such that the conveyor 140 may provide the card carriers to the gantry 110. For example, the flipper arms 272 may engage one of the card carriers positioned in the engagement position in the flipper system 260 and flip the one of the card carriers from the flipper system 260 on to the conveyor 140. The flipper arms 272 may release the one of the card carriers onto the conveyor 140 so that the conveyor 140 can carry the one of the card carriers to the gantry 110. In some embodiments (e.g., embodiments where the flipper system 260 includes the flipper upper rollers 262, etc.), the flipper upper actuator 264 moves the flipper upper rollers 262 from the lowered position to the raised position before the flipper system 260 transfers the card carriers from the flipper system 260 to the conveyor 140. For example, the flipper upper rollers 262 may move the card carriers to the engagement position while in the lowered position, hold the card carriers in place while the flipper arms 272 engage the card carriers, and then the flipper upper actuator 264 may move the flipper upper rollers 262 from the lowered position to the raised position before the flipper system 260 transfers the card carriers from the flipper system 260 to the conveyor 140.

In some embodiments, the flipper arms 272 are configured to engage a downward facing surface of the card carriers and flip the card carriers onto the conveyor 140 such that the downward facing surface where the flipper arms 272 are engaged becomes an upward facing surface. For example, the flipper arms 272 may engage a first surface of the card carriers that is orientated downwards (e.g., facing downwards, etc.) and a second surface of the card carriers that is not engaged by the flipper arms 272 (e.g., positioned opposite the first surface, etc.) may be orientated upwards (e.g., facing upwards, etc.). When the flipper arms 272 transfer the card carriers to the conveyor 140, the flipper arms 272 may rotated the card carriers such that the first surface engaged by the flipper arms 272 is orientated upwards and the second surface of the card carriers is orientated downwards. The flipper arms 272 may allow for the printing system 200 to change an upwards/downwards orientation of the surfaces of the card carriers printed by the printer 210 prior to the card carriers reaching the gantry 110 and the cards being attached to the card carriers.

In some embodiments, the flipper upper rollers 262 and/or the flipper lower rollers 266 are configured to transfer the card carriers from the flipper system 260 to the conveyor 140 such that the conveyor 140 may provide the card carriers to the gantry 110. For example, the flipper upper rollers 262 and/or the flipper lower rollers 266 may move the card carriers in the second transfer direction past the flipper arms 272 onto the conveyor 140 without the flipper arms 272 engaging the card carriers. When the card carriers are moved from the flipper system 260 to the conveyor 140 by the flipper upper rollers 262 and/or the flipper lower rollers 266, the card carriers can be transferred from the printing system 200 to the conveyor 140 without flipping the orientation of the card carriers. This may allow for the printing system 200 to selectively change the upwards/downwards orientation of the surfaces of the card carriers by transferring the card carriers from the flipper system 260 to the conveyor 140 using the flipper arms 272 or not change the upwards/downwards orientation of the surfaces of the card carriers by transferring the card carriers from the flipper system 260 to the conveyor 140 using the flipper upper rollers 262 and/or the flipper lower rollers 266.

In some embodiments, the flipper conveyors 268 are configured to transfer the card carriers from the flipper system 260 to the conveyor 140 such that the conveyor 140 may provide the card carriers to the gantry 110. For example, the flipper conveyors 268 may move the card carriers in the second transfer direction past the flipper arms 272 onto the conveyor 140 without the flipper arms 272 engaging the card carriers. When the card carriers are moved from the flipper system 260 to the conveyor 140 by the flipper conveyors 268, the card carriers can be transferred from the printing system 200 to the conveyor 140 without flipping the orientation of the card carriers. This may allow for the printing system 200 to selectively change the upwards/downwards orientation of the surfaces of the card carriers by transferring the card carriers from the flipper system 260 to the conveyor 140 using the flipper arms 272 or not change the upwards/downwards orientation of the surfaces of the card carriers by transferring the card carriers from the flipper system 260 to the conveyor 140 using the flipper conveyors 268.

As shown in FIG. 10, the flipper arms 272 may be configured to pivot around an axis AF (e.g., a pivot axis, a flip axis, etc.) and to flip the card carriers around the axis A F. The axis AF may be perpendicular to the second transfer direction of the printing system 200. For example, the axis AF may be perpendicular to the second transfer direction that the printing system 200 is configured to move the card carriers when the printing system 200 transfers the card carriers from the transfer system 230 to the flipper system 260. The axis AF may be parallel to the first transfer direction of the printing system 200. For example, the axis AF may be parallel to the first transfer direction that the printing system 200 is configured to move the card carriers when the printing system 200 transfers the card carriers from the buffer system 220 to the transfer system 230.

Each of the flipper arms 272 may include a flipper cup 274 (e.g., a flipper suction cup, etc.) configured to apply suction to the card carrier when the flipper arms 272 engage the card carriers. For example, the flipper arms 272 may include a venturi configured to provide suction to the flipper cup 274 to pick up the card carrier. A level of suction or pressure may be used to determine when the card carrier has been picked up. For example, when the card carriers are in the engagement position, the flipper cups 274 may apply suction on a surface of the card carriers to engage the card carriers with the flipper arms 272. Once the flipper arms 272 have moved the card carriers over the conveyor 140, the flipper cups 274 may release the suction on the surface of the card carriers to release the card carriers from the flipper arms 272 such that the card carriers are positioned on the conveyor 140 and may be moved by the conveyor 140. In other embodiments, the flipper arms 272 include a different component configured to engage the card carriers (e.g., a grasping arm, an adhesive arm, etc.)

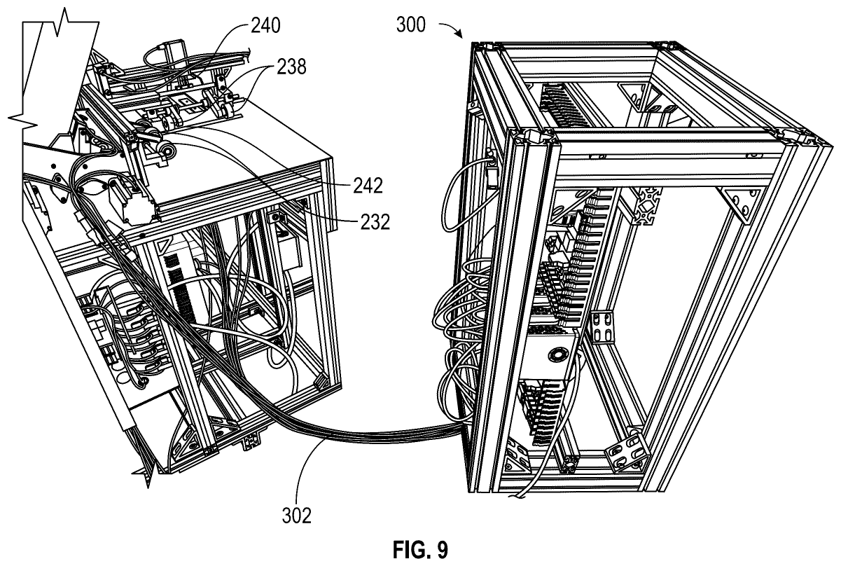

As shown in FIG. 9, the card attachment system 100 may include a controller 300 (e.g., a computing system, a processor, etc.) configured to provide control signals to and receive data from the elements of the card attachment system 100 to operate the elements of the card attachment system 100. The controller 300 may be electrically coupled to at least one of the elements of the card attachment system 100 via a cable 302. In some embodiments, the card attachment system 100 includes a plurality of the cables 302 electrically coupled between the controller 300 and various elements of the card attachment system 100. In some embodiments, the controller 300 may wirelessly communicate (e.g., via Bluetooth, via a local area network, via a wireless network, etc.) with at least one of the elements of the card attachment system 100.

### V. Process for Printing a Card Carrier

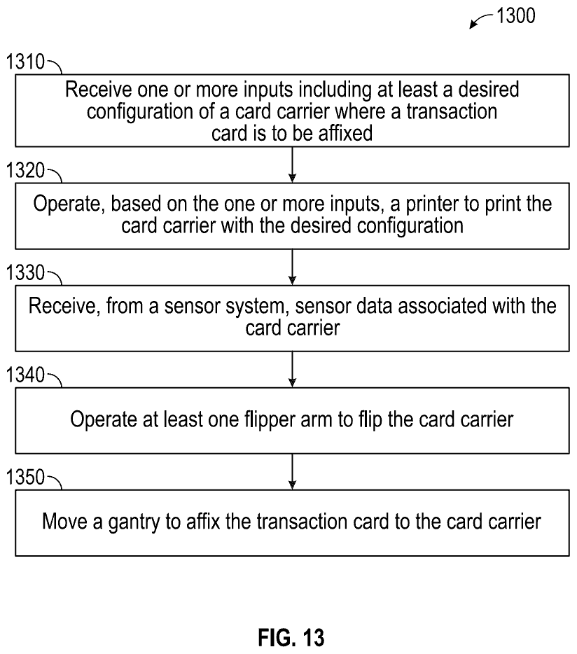

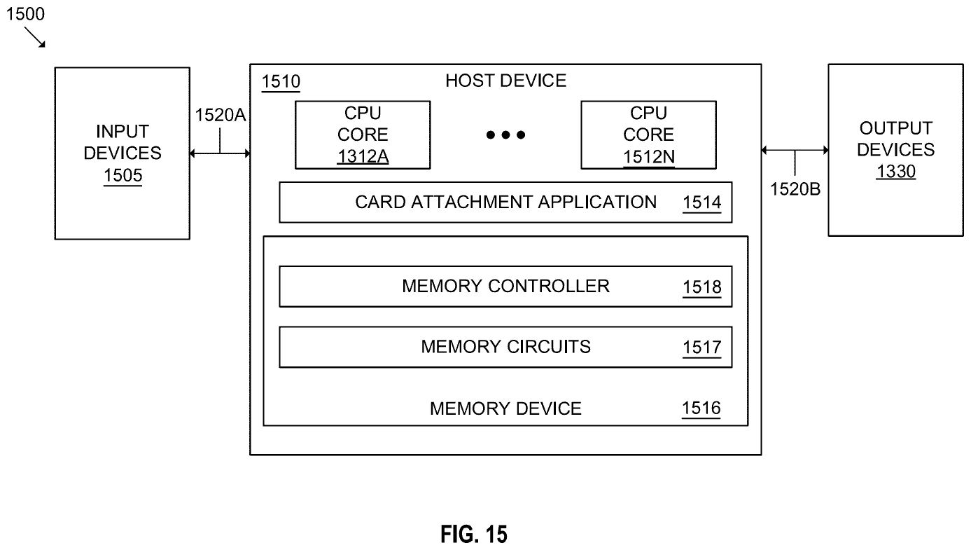

FIG. 13 is an example flowchart illustrating a process 1300 for printing a card carrier and attaching a card to the card carrier using the card attachment system 100 of FIG. 1. Additional, fewer, or different operations may be performed in the method, depending on the embodiment. Further, the operations may be performed in the order shown, concurrently, or in a different order. The operations illustrated in the process 1300 may be performed by a controller of a card attachment system such as the card attachment system 100 described herein. An example of the controller is shown in FIG. 15.

At step 1310, the controller may receive one or more inputs including at least a desired configuration of a card carrier where a transaction card is to be affixed. For example, the desired configuration of the card carrier may include a type of the card carrier, a color scheme of the card carrier, a shape of the card carrier, or another characteristic of the card carrier. In some embodiments, the controller may receive one or more inputs including a desired location on the card carrier where a transaction card is to be affixed and/or a desired orientation of the transaction card on the card carrier. In some embodiments, the one or more inputs may be entered by a user. In some embodiments, a first set of the one or more inputs is entered by the user and a second set of the one or more inputs is determined based on the desired configuration of the card carrier. For example, in some embodiments, the desired configuration of the card carrier may be a sheet of paper and may be associated with a location and an orientation of a transaction card.

At step 1320, the controller may operate, based on the one or more inputs, the printer 210 to print the card carrier with the desired configuration. For example, the controller may send a command to the printer 210 to print the card carrier that corresponds to the type of the card carrier from the desired configuration of the card carrier. For example, if the one or more inputs correspond to a configuration of the card carrier that depicts a mountain landscape, the controller may operate the printer 210 to print the card carrier with the desired configuration that depicts the mountain landscape.

At step 1330, the controller may receive sensor data associated with the card carrier from the sensor system. For example, the controller may receive sensor data from the sensor system 250 associated with the card carrier. The sensor data may be generated by the sensor system 250 when the card carrier is positioned in at least one of the buffer system 220, the transfer system 230, or the flipper system 260. The sensor data may include data generated by the lower sensor 252 corresponding to a downward facing surface of the card carrier when the card carrier passes the lower sensor 252. The sensor data may include data generated by the upper sensor 254 corresponding to an upward facing surface of the card carrier when the card carrier passes the upper sensor 254. The controller may use the sensor data to generate conveying data based on job data which includes card account data, card placement, card rotation, and card quantity of the card or cards to be attached to the card carrier. The conveying data may be used by the controller to generate commands for subsequent elements of the card attachment system.

In some embodiments, the controller may operate the buffer system 220 to store the card carrier printed by the printer 210. For example, the buffer system 220 may be positioned proximate the printer outlet 212 of the printer 210 and may receive the card carrier printed by the printer in step 1320. The controller may operate the buffer system 220 to provide the card carrier to the transfer system 230 after determining that the transfer system 230 is prepared to handle the card carrier. For example, the controller may receive the sensor data from the sensor system 250 indicating that a previous of the card carriers is positioned in the transfer system 230. The controller may operate the buffer system 220 to store the card carrier printed during step 1320 until the sensor data indicates that the previous of the card carriers has cleared the transfer system (e.g., the previous of the card carriers is positioned in the flipper system 260, the previous of the card carriers is positioned on the conveyor 140, etc.). Once the controller has determined that the previous of the card carriers has cleared the transfer system 230, the controller may operate the buffer system 220 to provide the card carrier from the buffer system 220 to the transfer system 230. As a result, the flow of the card carriers through the printing system 200 may be controlled such that a single of the card carriers passes through the transfer system 230 and/or the flipper system 260 at a time.

In some embodiments, the controller may operate the transfer system 230 to transfer the card carrier from the buffer system 220 to the flipper system 260. For example, the controller may operate the intake upper rollers 232 and the intake lower rollers 236 to move the card carrier in the direction away from the buffer system 220 and towards the transfer system 230. Once the card carrier is positioned in the transfer system 230, the controller may operate the outtake upper actuator 240 to pivot the outtake upper rollers 238 to the lowered position to contact the card carrier and operate the intake upper actuator 234 to pivot the intake upper rollers 232 into the raised position to not contact the card carrier. The controller may operate the outtake upper rollers 238 and the outtake lower rollers 242 to transfer the card carrier from the transfer system 230 to the flipper system 260. In some embodiments, the intake upper rollers 232 and the intake lower rollers 236 may move the card carriers in the first transfer direction and the outtake upper rollers 238 and the outtake lower rollers 242 may move the card carriers in the second transfer direction that is perpendicular to the first transfer direction.

In some embodiments, the controller receives the sensor data from the sensor system 250 while the card carrier is positioned in the transfer system 230. For example, the controller may receive the sensor data from the sensor system 250 between when the intake upper rollers 232 and the intake lower rollers 236 transfer the card carriers from the buffer system 220 to the transfer system 230 and when the outtake upper rollers 238 and the outtake lower rollers 242 transfer the card carriers from the transfer system 230 to the flipper system 260.

At step 1340, the controller may operate the flipper arms 272 to flip the card carrier. The controller may operate the flipper arms 272 to engage the card carrier positioned in the flipper system 260 and flip the card carrier such that an upward facing surface of the card carrier becomes a downward facing surface and a downward facing surface of the card carrier becomes an upward facing surface. In some embodiments, the controller may operate the flipper arms 272 to flip the card carrier onto the conveyor 140. For example, the flipper arms 272 may engage the card carrier when the card carrier is positioned in the flipper system 260 and may flip the card carrier from the flipper system 260 onto the conveyor 140 so that the conveyor 140 can transport the card carrier to the gantry 110. The controller may operate the flipper arms 272 to engage the card carriers by operating a venturi to provide suction to the flipper cups 274 of the flipper arms 272. The suction of the flipper cups 274 may suck onto the downward facing surface of the card carrier to engage the flipper arms 272 to the card carrier so that the flipper arms 272 can flip the card carrier without disengaging from the card carrier. Once the flipper arms 272 have flipped the card carrier, the controller may operate the venturi to cease providing suction to the flipper cups 274 to disengage the flipper arms 272 from the card carrier. For example, the controller may operate the venturi to cease providing suction to the flipper cups 274 when the flipper arms 272 have flipped the card carrier and the card carrier is positioned over the conveyor 140 so that when the flipper arms 272 disengage from the card carrier, the card carrier is positioned on the conveyor 140 (e.g., the card carrier drops down onto the conveyor 140, etc.).

In some embodiments, the controller may operate the flipper arms 272 to flip the card carrier based on the sensor data. For example, the controller may operate the flipper arms 272 to flip the card carrier responsive to determining, based on the sensor data, that the transaction card will be affixed to the downward facing surface of the card carrier by the gantry 110. As such, when the card carrier is flipped by the flipper arms 272, the downward facing surface of the card carrier becomes the upward facing surface of the card carrier such that the gantry 110 may affix the transaction card onto the now upward facing surface of the card carrier. In some embodiments, the controller may not operate the flipper arms 272 to flip the card carrier based on the sensor data. For example, the controller may not operate the flipper arms 272 to not flip the card carrier responsive to determining, based on the sensor data, that the transaction card will be affixed to the upward facing surface of the card carrier by the gantry 110. As such, the card carrier does not need to be flipped by the flipper arms 272 so that the gantry 110 may affix the transaction card onto the current upward facing surface of the card carrier.

At step 1350, the controller is configured to move the gantry 110 to affix the transaction card to the card carrier. The controller may move and rotate the first arm 120a according to the one or more inputs to affix the transaction card to the card carrier according to the one or more inputs. In some embodiments, the controller may move and rotate the first arm 120a according to the sensor data received at step 1330. The controller may move the first arm 120a by sending signals to motors of the gantry 110 and/or the first arm 120a. In some embodiments, the controller may move the arm to pick up the transaction card and hold it above the card carrier and then move and rotate the arm to affix the transaction card to the card carrier. In some embodiments, the one or more inputs may include at least one of a material of the card carrier, a size of the second card carrier, a thickness of the card carrier, or a type of the card carrier. For example, in some embodiments, the thickness of the card carrier may determine how far the controller moves the arms down to affix the transaction cards to the card carriers. Similarly, the type of the card carrier, such as a paper or a box product, may determine how far the controller moves the first arm 120a and/or second arm 120b down to affix the transaction cards to the card carrier.

In some embodiments, the controller is further configured to determine a position of one or more edges of the card carrier as the card carrier travels on the conveyor towards the gantry in the first direction. The controller may determine the position of the one or more edges of the card carrier using an edge sensor such as the position sensor 190 of FIG. 2. The controller may calculate, based on the position of the one or more edges of the card carrier, an offset indicating a difference between a default position of the card carrier and the desired location. The controller may calculate, based on the offset, a new location on the card carrier to affix the transaction card to the card carrier. The controller may move the first arm 120a of the gantry 110 based on the one or more inputs in the second direction perpendicular to the first direction and in a third direction perpendicular to the first direction and the second direction by moving the first arm of the gantry based on the new location of the card carrier to affix the transaction card to the card carrier in the desired location and the desired orientation. For example, in some embodiments, the default position of the card carrier may be where the card carrier is centered on the conveyor 140. The controller may determine that an edge of the card carrier is shifted 3 mm left relative to the default position, meaning that the offset between the default position of the card carrier and the desired location is 3 mm left. The controller may calculate the new position of the card carrier to be 3 mm to the left relative to the default position of the card carrier.

The controller may move and rotate the first arm 120a based on the one or more inputs and the new position of the card carrier to affix the transaction card to the card carrier in the desired location and the desired orientation.

In some embodiments, the operations of the process 1300 may be performed with a first card carrier and a second card carrier such that a first transaction card is affixed to a first card carrier by the first arm and a second transaction card is affixed to a second card carrier by the second arm. The controller may move the first arm 120a and the second arm 120b simultaneously and/or independently. Sensors on the gantry 110 and/or the first arm 120a and second arm 120b may allow the controller to avoid collisions between the first arm 120a and the second arm 120b. In other embodiments, the operations of the process 1300 may be performed with the card carrier such that a first transaction card is affixed to the card carrier by the first arm and a second transaction card is affixed to the card carrier by the second arm.

### VI. Block Diagram of Card Attachment System

FIG. 12 is an example block diagram illustrating a card attachment system 1400, in accordance with one or more embodiments. The card attachment system 1400 has the same elements as the card attachment system 100, so those elements are not described again. A controller 1402 (shown in FIG. 15) may provide commands (e.g., control signals, control outputs, etc.) to the card attachment system 1400 to operate the elements of the card attachment system 1400. The controller 1402 may receive user input and interaction through a GUI 1404 of the card attachment system 1400. The controller 1402 may receive job data 1411 and performance data 1412. The job data 1411 may include what tasks are to be performed, such as which cards are to be attached to which card carriers, and in which locations and orientations on the card carriers. The job data 1411 may also include folds which are to be made in the card carriers. The performance data 1412 may include information on how the tasks are being performed, such as a progress in completing the tasks, an accuracy of completing the tasks, and system errors. The job data 1411 and performance data 1412 may be displayed on the GUI 1404. The controller 1402 and/or the GUI 1404 may authenticate a user to allow the user to run the card attachment system 1400. The controller 1402 and/or the GUI 1404 may decrypt the job data 1411. The controller 1402 may be communicatively coupled to any of the elements of the card attachment system 1400 to provide the commands to the elements of the card attachment system 1400.

The controller 1402 may send commands to a printer 1420. The printer 1420 may print card carriers and provide the card carriers to a buffer 1422. The printer 1420 is similar to the printer 210. The printer 1420 may print different styles of card carriers based on the cards that will be attached to the card carriers. For example, the printer 1420 may print a first style of card carriers associated with a first set of cards and a second style of card carriers associated with a second set of cards. In some embodiments, the printer 1420 may perforate or cut the card carriers based on the cards that will be attached to the card carriers and a desired final form of the card carriers. For example, if the card carriers will be folded after a card is attached to each of the card carriers, the printer 1420 may perforate the card carriers along a line where the card carriers will be folded to ease the process of folding the card carriers.

The printer 1420 may provide the card carriers to a buffer 1422. The buffer 1422 may store the card carriers provided to the buffer 1422 until receiving commands from the controller 1402 to transfer the card carriers to a transfer system 1424. For example, the buffer 1422 may store the card carriers until the controller 1402 determines that subsequent components of the card attachment system 1400 are ready to receive the card carriers. The buffer 1422 is similar to the buffer system 220. In some embodiments, the buffer 1422 may be configured to receive multiple of the card carriers from the printer 1420 and store the card carriers. For example, the buffer 1422 may index the card carriers until receiving commands from the controller 1402 to transfer the card carriers. The buffer 1422 may be configured to individually transfer the card carriers indexed in the buffer 1422 to the transfer system 1424. For example, if the buffer 1422 has three card carriers indexed within the buffer 1422, the buffer 1422 may separately transfer a first of the card carriers to the transfer system 1424, a second of the card carriers to the transfer system 1424, and a third of the card carriers to the transfer system 1424.

The transfer system 1424 may receive the card carriers from the buffer 1422 and transfer the card carriers to a flipper system 1432. The transfer system 1424 is similar to the transfer system 230. In some embodiments, the transfer system 1424 is configured to receive the card carriers moving in a first transfer direction from the buffer 1422 and provide the card carriers moving in a second transfer direction to the flipper system 1432. The first transfer direction may be perpendicular to the second transfer direction such that the card carriers are provided by the transfer system 1424 traveling in a different direction than the card carriers are traveling when the card carriers are received by the transfer system.

A carrier sensor system 1426 may scan surfaces of the card carriers while the card carriers are traveling through the transfer system 1424. The controller 1402 may receive sensor data from the carrier sensor system 1426 to determine an identifier of a card carrier and/or to determine that a single of the card carriers is present within the transfer system 1424 at a time. In some embodiments, the controller 1402 may use the sensor data from the carrier sensor system 1426 to determine that a card carrier is not present within the transfer system 1424 and operate the buffer 1422 to provide a card carrier to the transfer system 1424 based on determining that the card carrier is not present within the transfer system 1424. The carrier sensor system 1426 may include a lower scanner 1428 configured to scan a downward facing surface of the card carriers and an upper scanner 1430 configured to scan an upward facing surface of the card carriers.

The controller 1402 may use the sensor data from the carrier sensor system 1426 to generate conveying data based on the job data which includes card account data, card placement, card rotation, and card quantity of the card or cards to be attached to the card carrier. The conveying data may be used by the controller 1402 to generate commands for subsequent elements of the card attachment system 1400.

The flipper system 1432 may receive the card carriers from the transfer system 1424 and provide the card carriers to a first carrier transport section 1440 (e.g., the conveyor 140, etc.). The flipper system 1432 may be similar to the flipper system 260. The flipper system 1432 may flip the card carriers while providing the card carriers to the first carrier transport section 1440 such that a downward facing surface of the card carrier becomes an upward facing surface and an upward facing surface of the card carrier becomes a downward facing surface.

In some embodiments, the flipper system 1432 may selectively flip the card carriers while providing the card carriers to the first carrier transport section 1440 such that the flipper system 1432 may either flip the card carriers while providing the card carriers to the first carrier transport section 1440 or not flip the card carriers while providing the card carriers to the first carrier transport section 1440. The controller 1402 may send commands to the flipper system 1432 to flip the card carriers or to not flip the card carriers based on the sensor data from the carrier sensor system 1426. For example, if the sensor data indicates that a card attachment surface of the card carrier is the downward facing surface, then the controller 1402 may send a command to the flipper system 1432 to flip the card carrier while providing the card carrier to the first carrier transport section 1440 (e.g., when the cards are configured to be attached to an upward facing surface of the card carriers, etc.). As another example, if the sensor data indicates that a card attachment surface of the card carrier is the upward facing surface, then the controller 1402 may send a command to the flipper system 1432 to provide the card carrier to the first carrier transport section 1440 without flipping the card carrier.

The first carrier transport section 1440 may be a conveyor belt (e.g., the conveyor 140 of FIG. 1) which transports the card carriers towards a gantry (e.g., the gantry 110). The first carrier transport section 1440 may include stop pins configured to straighten a card carrier on the first carrier transport section 1440. The stop pins may extend through the first carrier transport section 1440 to stop the card carrier as it is transported towards the gantry, straightening the card carrier relative to the stop pins. The first carrier transport section 1440 may deliver the card carriers to a second carrier transport section 1442. The second carrier transport section 1442 may include a sensor (e.g., the position sensor 190) which determines a position a card carrier on the second carrier transport section to calculate an offset. The offset may be used to precisely place a card on the card carrier. The second carrier transport section 1442 may deliver the card carriers to a third carrier transport section 1444. The third carrier transport section 1444 may bring the card carriers to the gantry for attachment of cards and may position the card carriers for the attachment of the cards based on the job data. In some embodiments, the carrier transport may include more or fewer carrier transport sections.

The GUI 1404 and/or the controller may send commands to a card picker. The card picker 1460 may, based on the job data, retrieve cards for attachment to the card carriers. The card picker 1460 may deliver the cards to a card reader 1462 (e.g., the card reader 150) which determines a card identifier of each card. The card reader 1462 may generate conveying data for each. The card reader 1462 may deliver the cards to a first card transport section 1464 which may deliver the cards to a second card transport section 1466. The second card transport section 1466 may capture a position of each card for tape placement and deliver the cards to a third card transport section 1468 which may apply tape to a back of each card. The third card transport section 1468 may deliver the cards to a fourth card transport section 1470 which may deliver the cards to a card stager (e.g., the stager 160). The first card transport section 1464, the second card transport section 1466, the third card transport section 1468, and the fourth card transport section 1470 may provide a buffer to the controller to match the cards to carriers, determine that one or more of the cards should be placed in a soft reject area 1486, or determine that one or more of the cards should be placed in a hard reject area 1482, as discussed herein. In some embodiments, the card reader 1462 may deliver the cards directly to the card stager. In other embodiments, the card reader 1462 may deliver the cards to the card stager using more or fewer card transport sections. The card stager may include a first card stager section 1472, a second card stager section 1474, a third card stager section 1476, a fourth card stager section 1478, and a fifth card stager section 1480. In some embodiments, the card stager may include more or fewer card stager sections. The fourth card transport section 1470 may deliver each card to a section of the card stager based on the job data. In some embodiments, the fourth card transport section 1470 is static, and the card stager sections move in order for each card to be delivered to a correct card stager section. The card stager may also include the hard reject area 1482. A hard reject requires a rejected card carrier to be retrieved by an operator of the card attachment system 1400. A card may be delivered to the hard reject area 1482 based on the card being associated with a card carrier that has already passed the gantry, which was not delivered to the gantry, or that is otherwise unavailable. Cards in the hard reject area 1482 may be retrieved by an operator of the card attachment system 1400. The gantry arms 1484 may retrieve cards from the card stager and attach them to card carriers on the third carrier transport section 1456. The card stager may shift at least one of the first card stager section 1472, the second card stager section 1474, the third card stager section 1476, the fourth card stager section 1478, or the fifth card stager section 1480 left or right to facilitate retrieval by the gantry arms 1484 (e.g., the one or more arms 120) of the cards. The gantry arms may place cards in the soft reject area 1486 (e.g., the soft reject area 170) based on the cards being associated with card carriers which have not yet been delivered to the third carrier transport section 1456. The gantry arms 1484 may retrieve the cards from the soft reject area 1486 and place them on their respective card carriers once the respective card carriers reach the third carrier transport section 1456.

Card carriers may be delivered by the third carrier transport section 1456 to a positioner 1488 (e.g., the positioner 185). The positioner 1488 may deliver card carriers to a carrier hard reject area 1490 based on the card carriers not having attached cards or the cards being attached incorrectly to the card carriers. The positioner 1488 may position card carriers with attached cards based on job data such that a plow folder 1492 (e.g., the folder 180) makes one or more folds in the card carriers with attached cards in accordance with the job data. The card carriers with attached cards may pass through the plow folder 1492 to an output 1494 which verifies that the cards are attached to the card carriers using a plurality of sensors. The card attachment system 1400 may include a plurality of sensors for determining identifiers of cards, identifiers of card carriers, and for conveying the cards and card carriers throughout the card attachment system 1400.

### VII. Computing System

FIG. 13 is an example block diagram of the computing system 1500 implementing a card attachment application, in accordance with one or more embodiments. The computing system 1500 includes a host device 1510. The host device 1510 includes a memory device 1516. In other embodiments, the memory device 1516 associated with the host device 1510 is a separate device that is communicatively coupled to the host device 1510 instead. The host device 1510 may be configured to receive input from one or more input devices 1505 and provide output to one or more output devices 1530. The host device 1510 may be configured to communicate with the input devices 1505 and the output devices 1530 via appropriate interfaces or channels 1520A and 1520B, respectively. The computing system 1500 may be implemented in a variety of computing devices such as computers (e.g., desktop, laptop, etc.), tablets, personal digital assistants, mobile devices, wearable computing devices such as smart watches, other handheld or portable devices, or any other computing unit suitable for performing operations described herein using the host device 1510. In some embodiments, the card attachment system 100 includes the computing system 1500.

Further, some or all of the features described in the present disclosure may be implemented on a client device, a server device, or a cloud/distributed computing environment, or a combination thereof. Additionally, unless otherwise indicated, functions described herein as being performed by a computing device (e.g., the computing system 1500) may be implemented by multiple computing devices in a distributed environment, and vice versa. In some embodiments, the computing system 1500 or at least some of the features described herein may be implemented in an in-vehicle system (e.g., tablet) that may be configured to perform at least some of the operations described herein and report those out to a server while, in other embodiments, the server may perform the operations.

The input devices 1505 may include any of a variety of input technologies such as a keyboard, stylus, touch screen, mouse, conveyor ball, keypad, microphone, voice recognition, motion recognition, remote controllers, input ports, one or more buttons, dials, joysticks, camera, and any other input peripheral that is associated with the host device 1510 and that allows an external source, such as a user, to enter information (e.g., data) into the host device and send instructions to the host device 1510. Similarly, the output devices 1530 may include a variety of output technologies such as external memories, printers, speakers, displays, microphones, light emitting diodes, headphones, plotters, speech generating devices, video devices, global positioning systems, and any other output peripherals that are configured to receive information (e.g., data) from the host device 1510. The “data” that is either input into the host device 1510 and/or output from the host device may include any of a variety of textual data, graphical data, video data, image data, sound data, position data, sensor data, combinations thereof, or other types of analog and/or digital data that is suitable for processing using the computing system 1500.

The host device 1510 may include one or more Central Processing Unit (“CPU”) cores or that may be configured to execute instructions for running one or more applications associated with the host device 1510. In some embodiments, the instructions and data needed to run the one or more applications may be stored within the memory device 1516. The host device 1510 may also be configured to store the results of running the one or more applications within the memory device 1516. One such application on the host device 1510 may include a card attachment application 1514. The card attachment application 1514 may be executed by one or more of the processors 1512A-1312N. The instructions to execute the card attachment application 1514 may be stored within the memory device 1516. Operations performed by the card attachment application 1514 in conjunction with a card attachment system described herein. Thus, the host device 1510 may be configured to request the memory device 1516 to perform a variety of operations. For example, in some embodiments, the host device 1510 may request the memory device 1516 to read data, write data, update, or delete data, and/or perform management or other operations.

To facilitate communication with the memory device 1516, the memory device 1516 may include or be associated with a memory controller 1518. Although the memory controller 1518 is shown as being part of the memory device 1516, in some embodiments, the memory controller 1518 may instead be part of another element of the computing system 1500 and operatively associated with the memory device 1516. For example, in some embodiments, when the memory device 1516 is a separate device from the host device 1510, the memory controller 1518 may be configured as a logical block or circuitry that receives instructions from the host device 1510 and performs operations in accordance with those instructions. For example, in some embodiments, when the execution of the card attachment application 1514 is desired, the host device 1510 may send a request to the memory controller 1518. The memory controller 1518 may read the instructions associated with the card attachment application 1514 that are stored within the memory device 1516 and send those instructions back to the host device 1510. Continuing with the example embodiment of the memory device 1516 being a separate device from the host device 1510, those instructions may be temporarily stored within a memory on the host device 1510. One or more of the processors 1512A-1312N may then execute those instructions by performing one or more operations called for by those instructions of the card attachment application 1514.

The memory device 1516 may include one or more memory circuits 1517 that store data and instructions. The memory circuits 1517 may be any of a variety of memory types, including a variety of volatile memories, non-volatile memories, or a combination thereof. For example, in some embodiments, in some embodiments, one or more of the memory circuits 1517 or portions thereof may include NAND flash memory cores. In other embodiments, one or more of the memory circuits 1517 or portions thereof may include NOR flash memory cores, Static Random Access Memory (SRAM) cores, Dynamic Random Access Memory (DRAM) cores, Magnetoresistive Random Access Memory (M RAM) cores, Phase Change Memory (PCM) cores, Resistive Random Access Memory (ReRAM) cores, 3D X Point memory cores, ferroelectric random-access memory (FeRAM) cores, and other types of memory cores that are suitable for use within the memory device 1516. In some embodiments, one or more of the memory circuits 1517 or portions thereof may be configured as other types of storage class memory (“SCM”). Generally speaking, the memory circuits 1517 may include any of a variety of Random Access Memory (RAM), Read-Only Memory (ROM), Programmable ROM (PROM), Erasable PROM (EPROM), Electrically EPROM (EEPROM), hard disk drives, flash drives, memory tapes, cloud memory, or any combination of primary and/or secondary memory that is suitable for performing the operations described herein.

It is to be understood that only some components of the computing system 1500 are shown and described in FIG. 13. However, the computing system 1500 may include other components such as various batteries and power sources, networking interfaces, routers, switches, external memory systems, controllers, cameras, barcode readers, safety circuits, etc. Generally speaking, the computing system 1500 may include any of a variety of hardware, software, and/or firmware components that are needed or considered desirable in performing the functions described herein. Similarly, the host device 1510, the input devices 1505, the output devices 1530, and the memory device 1516, including the memory controller 1518 and the memory circuits 1517, may include hardware, software, and/or firmware components that are considered necessary or desirable in performing the functions described herein. In addition, in certain embodiments, the memory device 1516 may integrate some or all of the components of the host device 1510, including, for example, the processors 1512A-1312N, and the processors may be configured to execute the card attachment application 1514, as described herein.

It is to be understood that any examples used herein are simply for purposes of explanation and are not intended to be limiting in any way. It is also to be understood that any examples used herein are simply for purposes of explanation and are not intended to be limiting in any way. Further, although the present disclosure has been discussed with respect to memory usage, in other embodiments, the teachings of the present disclosure may be applied to adjust other resources, such as power, processing capacity, etc.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality if effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

1. An apparatus comprising:
a gantry comprising an arm configured to affix a transaction card to a card carrier;
a conveyor configured to convey the card carrier to the gantry in a first direction relative to the gantry for affixing the transaction card to the card carrier;
a flipper system comprising at least one flipper arm configured to engage the card carrier and flip the card carrier onto the conveyor, wherein the at least one flipper arm is configured to flip the card carrier such that a downward facing surface of the card carrier becomes an upward facing surface; and
a controller configured to:
receive one or more inputs comprising at least a desired location on the card carrier where the transaction card is to be affixed and a desired orientation of the transaction card on the card carrier;
determine that the card carrier has been received by the flipper system;
operate the at least one flipper arm to engage the card carrier and flip the card carrier onto the conveyor;
move the arm of the gantry based on the one or more inputs in a second direction perpendicular to the first direction and in a third direction perpendicular to the first direction and the second direction; and
affix the transaction card to the card carrier by the arm of the gantry.

2. The apparatus of claim 1, wherein prior to operating the at least one flipper arm to engage the card carrier, the controller is further configured to:
receive, from a sensor system, sensor data associated with the card carrier; and
determine, based on the sensor data, that the card carrier has been received by the at least one flipper arm.

3. The apparatus of claim 2, wherein the controller is further configured to:
move the arm of the gantry based on the sensor data in the second direction and the third direction.

4. The apparatus of claim 2, further comprising:
a transfer system configured to receive the card carrier from a first transfer direction and provide the card carrier to the flipper system in a second transfer direction perpendicular to the first transfer direction;
wherein the sensor data is associated with the card carrier when the card carrier is positioned in the transfer system; and
wherein the controller is further configured to:
determine, based on the sensor data, that the card carrier is positioned in the transfer system; and
operate the transfer system to provide the card carrier to the flipper system in the second transfer direction.

5. The apparatus of claim 4, wherein the transfer system further comprises:
a plurality of intake rollers configured to move the card carrier in the first transfer direction; and
a plurality of outtake rollers configured to move the card carrier in the second direction;
wherein the controller is further configured to:
operate the plurality of intake rollers to move the card carrier in the first transfer direction prior to receiving the sensor data; and
operate the plurality of outtake rollers to move the card carrier in the second transfer direction after receiving the sensor data.

6. The apparatus of claim 5, wherein the transfer system further comprises:
an intake actuator configured to move the plurality of intake rollers between an engagement position where the plurality of intake rollers are configured to engage the card carrier and a disengagement position where the plurality of intake rollers are configured to not engage the card carrier; and
an outtake actuator configured to move the plurality of outtake rollers between the engagement position where the plurality of outtake rollers are configured to engage the card carrier and the disengagement position where the plurality of outtake rollers are not configured to engage the card carrier;
wherein the controller is further configured to:
operate the intake actuator to position the plurality of intake rollers in the engagement position and operate the outtake actuator to position the plurality of outtake rollers in the disengagement position prior to operating the plurality of intake rollers to move the card carrier in the first transfer direction; and
operate the intake actuator to position the plurality of intake rollers in the disengagement position and operate the outtake actuator to position the plurality of outtake rollers in the engagement position prior to operating the plurality of outtake rollers to move the card carrier in the second transfer direction.

7. The apparatus of claim 6, wherein the controller is further configured to:
operate the outtake actuator to position the plurality of outtake rollers in the engagement position prior to receiving the sensor data.

8. The apparatus of claim 4, wherein:
the transfer system is configured to receive the card carrier from a printer; and
the controller is further configured to:
operate the printer to print the card carrier based on the one or more inputs.

9. The apparatus of claim 8, wherein the one or more inputs further comprise at least one of a material of the card carrier, a size of the card carrier, a thickness of the card carrier, or a type of the card carrier.

10. The apparatus of claim 4 further comprising:
a buffer system configured to store a plurality of card carriers, the buffer system configured to provide the card carrier to the transfer system in the first transfer direction;
wherein responsive to determining that a previous card carrier has been provided from the transfer system to the flipper system, the controller is further configured to operate the buffer system to provide the card carrier to the transfer system in the first transfer direction.

11. The apparatus of claim 10, wherein:
the buffer system is configured to receive the card carrier from a printer; and
the controller is further configured to:
operate the printer to print the card carrier based on the one or more inputs.

12. The apparatus of claim 1, wherein the at least one flipper arm comprise a venturi configured to provide suction to engage the card carrier for flipping the card carrier onto the conveyor.

13. The apparatus of claim 12, wherein the at least one flipper arm is configured to engage the downward facing surface of the card carrier prior to flipping the card carrier and disengage from the upward facing surface after flipping the card carrier.

14. The apparatus of claim 12, wherein:
the flipper system further comprises a plurality of intake rollers configured to move the card carrier in the second direction; and
the controller is further configured to:
operate the plurality of intake rollers to move the card carrier in the second direction prior to operating the at least one flipper arm to engage the card carrier.

15. The apparatus of claim 14, wherein:
the flipper system further comprises an intake actuator configured to move the plurality of intake rollers between an engagement position where the plurality of intake rollers are configured to engage the card carrier and a disengagement position where the plurality of intake rollers are configured to not engage the card carrier; and
the controller is further configured to:
operate the intake actuator to position the plurality of intake rollers in the engagement position prior to operating the plurality of intake rollers to move the card carrier in the second direction; and
operate the intake actuator to position the plurality of intake rollers in the disengagement position after operating the at least one flipper arm to engage the card carrier but prior to operating the at least one flipper arm to flip the card carrier onto the conveyor.

16. The apparatus of claim 12, wherein:
the flipper system further comprises a flipper conveyor configured to move the card carrier in the second direction; and
the controller is further configured to:
operate the flipper conveyor to move the card carrier in the second direction prior to operating the at least one flipper arm to engage the card carrier.

17. A method comprising:
receiving, by a controller of a card attachment system, one or more inputs comprising at least a desired location on a card carrier where a transaction card is to be affixed and a desired orientation of the transaction card on the card carrier, wherein the card carrier is transported by a conveyor in a first direction towards a gantry of the card attachment system;
operating, by the controller, a printer to print the card carrier;
determining, by the controller, that the card carrier has been received by a flipper system from the printer, the flipper system comprising at least one flipper arm configured to engage the card carrier and flip the card carrier onto the conveyor, wherein the at least one flipper arm is configured to flip the card carrier such that a downward facing surface of the card carrier becomes an upward facing surface;
operating, by the controller, the at least one flipper arm to engage the card carrier and flip the card carrier onto the conveyor;
moving, by the controller, an arm of the gantry based on the one or more inputs in a second direction perpendicular to the first direction and in a third direction perpendicular to the first direction and the second direction; and
affixing, by the controller, the transaction card to the card carrier using the arm.

18. The method of claim 17, wherein prior to operating the at least one flipper arm to engage the card carrier, the method further comprises:
receiving, from a sensor system, sensor data associated with the card carrier; and
determining, based on the sensor data, that the card carrier has been received by the at least one flipper arm.

19. A non-transitory, computer-readable medium comprising computer-readable instructions which, when executed by a controller, cause the controller to:
receive one or more inputs comprising at least a desired location on a card carrier where a transaction card is to be affixed and a desired orientation of the transaction card on the card carrier, wherein the card carrier is transported by a conveyor in a first direction towards a gantry of a card attachment system;
operate a printer to print the card carrier;
determine that the card carrier has been received by a flipper system from the printer, the flipper system comprising at least one flipper arm configured to engage the card carrier and flip the card carrier onto the conveyor, wherein the at least one flipper arm is configured to flip the card carrier such that a downward facing surface of the card carrier becomes an upward facing surface;
operate the at least one flipper arm to engage the card carrier and flip the card carrier onto the conveyor;
move an arm of the gantry based on the one or more inputs in a second direction perpendicular to the first direction and in a third direction perpendicular to the first direction and the second direction; and
affix the transaction card to the card carrier using the arm.

20. The non-transitory, computer-readable medium of claim 19, further comprising instructions which cause the controller to:
receive, from a sensor system, sensor data associated with the card carrier; and
move the arm of the gantry based on the sensor data in the second direction and the third direction.
